(19) United States
(12) Patent Application Publication
(10) Pub. No.: US 2009/0227735 A1
(43) Pub. Date: Sep. 10, 2009

(54) MISCIBLE POLYESTER BLENDS AND SHRINKABLE FILMS PREPARED THEREFROM

(75) Inventors: Wayne Ken Shih, Kingsport, TN (US); Rondell Paul Little, JR., Elizabethton, TN (US)

Correspondence Address: ERIC D. MIDDLEMAS;EASTMAN CHEMICAL COMPANY, P. O. BOX 511, KINGSPORT, TN, 37662-5075, US

(73) Assignee: EASTMAN CHEMICAL COMPANY, Kingsport, TN (US)

(21) Appl. No.: 12/397,624

(22) Filed: Mar. 4, 2009

Related U.S. Application Data
(60) Provisional application No. 61/034,834, filed on Mar. 7, 2008.

(51) Int. Cl. C08L 1/08; C08L 67/03; C08L 3/04

(52) U.S. Cl. 525/54.21; 525/451; 525/54.24; 525/190

(57) ABSTRACT

Disclosed are polyester blends useful for the preparation of heat-shrinkable films, and heat-shrinkable films prepared therefrom. The heat shrinkable film may be oriented in the machine direction to produce films with high machine-direction shrinkage but low transverse growth or shrinkage. The films are useful for roll-fed, shrink-on label applications. Also disclosed are heat-shrinkable roll-fed labels prepared from reactor-grade polyesters.

### CROSS REFERENCE

This application claims the benefit of U.S. Provisional Application No. 61/034,834, filed, Mar. 7, 2008, which is incorporated by reference in its entirety.

### FIELD OF THE INVENTION

This invention pertains to miscible polyester blends and heat-shrinkable, polyester films prepared therefrom. More specifically, this invention pertains to heat-shrinkable, polyester films prepared from miscible polyester blends that are useful for wrap-around shrink label applications. This invention further pertains to heat-shrinkable roll-fed labels prepared from a reactor-grade polyester.

### BACKGROUND OF THE INVENTION

Heat-shrinkable or thermo-shrinkable films are well known and have found commercial acceptance in a variety of applications such as, for example, shrink wrap to hold objects together, coverings, and as an outer wrapping and labels for bottles, cans and other kinds of containers. Heat shrinkable plastic films are also used as an outer wrapping and label for batteries and are used to cover the cap, neck, shoulder or bulge sections of bottles or for the entire bottles. In addition, shrink films may be used as a wrapping or covering bundle such multiple objects such as boxes, bottles, boards, rods, or notebooks together in groups. These applications take advantage of the shrinkability and the internal shrink stress of the film.

Shrink films generally can be classified into two categories: (1) biaxially oriented films which are typically used for over-wrapping wherein the film shrinks in both the MD and TD directions, and (2) uniaxially oriented films which are widely used as tamper-evident labels on food and pharmaceutical products and as primary labels on beverage bottles. Uniaxially oriented films primarily shrink in the stretched or oriented direction and, ideally, have 0 to 10 percent shrinkage or growth in the unstretched or nonoriented direction.

The uniaxially oriented shrink films are further classified into two categories depending on if they are transverse direction oriented (“TDO”) or machine direction oriented (“MDO”). The TDO films are often produced using a tenter frame where the film is only stretched in the transverse direction (“TD”) while being constrained along the machine direction (“MD”). The stretching process minimizes any orientation in the machine direction, and these films can often meet the low shrinkage requirements in the unstretched or nonoriented direction. TDO polyester films have found significant use in the packaging industry. Usually these films are made into sleeves, placed around a container, and exposed to heat (typically hot air or infrared) or steam, which causes the sleeve to shrink tightly around the container.

Polyester films, however, typically are not used as MDO films. Machine direction oriented films typically are produced by stretching a web that is not constrained in the traverse direction. The webs are printed and each printed panel is cut into rolls of film which are used in wrap-around (also known as “roll-on-shrink-on” (“ROSO”)) label applications. Because of the lack of constraints in the traverse direction, these polyester webs frequently will “neck-in” while being stretched in the machine direction. The effect of the neck-in is to create uneven material distribution and stresses across the transverse direction of the web. The consequence of the uneven material distribution is that panels cut from different locations on the web (e.g., drive side, center, and operator side) will have different material distribution and stresses causing different amounts of TD growth or shrinkage. Labels made from different locations across a web will shrink differently, causing the printing to be different and the labels to be different heights. This lack of uniformity in finished labels is unacceptable.

As a consequence, polyester MDO films typically are not used for ROSO label applications. The neck-in phenomenon causes significant transverse direction growth and these films often do not meet the low shrinkage or growth requirement in the direction perpendicular to the main orientation direction. In addition, the effect of neck-in varies across the width of the web. Thus, when the web is cut into strips for labels, the strips cut from close to the web edge will have greater growth in the perpendicular direction than strips cut from the web center.

There is a need, therefore, for a polyester shrink film having high MD shrinkage, low total transverse direction growth or shrinkage, and low variability of the amount of transverse direction growth or shrinkage across the width of a web. Such a polyester shrink film may be used in ROSO applications to produce labels with consistent label height and finish after being applied to containers.

### SUMMARY OF THE INVENTION

In one embodiment, the invention provides a polyester blend that is useful for the preparation of heat shrinkable films having high MD shrinkage and low transverse growth. Thus, the invention provides a polyester blend comprising:

A. a first polyester comprising:
i. diacid residues comprising about 90 to 100 mole percent, based on the total first polyester diacid residues, of the residues of terephthalic acid; and
ii. diol residues comprising about 90 to 100 mole percent, based on the total first polyester diol residues, of the residues of ethylene glycol; and
   B. a second polyester comprising:
i. diacid residues comprising about 90 to 100 mole percent, based on the total second polyester diacid residues, of the residues of terephthalic acid; and
ii. diol residues comprising about 5 to about 89 mole percent, based on the total second polyester diol residues, of the residues of ethylene glycol, about 10 to about 70 mole percent of the residues of 1,4-cyclohexanedimethanol residues, and about 1 to about 25 mole percent of the residues of diethylene glycol;
   wherein the polyester blend comprises about 8 to about 15 mole percent, based on the total diol residues in the polyester blend, of the residues of 1,4-cyclohexanedimethanol. The polyesters of our blend are miscible and readily prepared by melt compounding the first and second polyester components.

Another aspect of our invention is a heat shrinkable film prepared from the above polyester blend. Hence, our invention also provides a heat shrinkable, polyester, film comprising a polyester blend, the polyester blend comprising:

A. a first polyester comprising:
i. diacid residues comprising about 90 to 100 mole percent, based on the total first polyester diacid residues, of the residues of terephthalic acid; and
ii. diol residues comprising about 90 to 100 mole percent, based on the total first polyester diol residues, of the residues of ethylene glycol;
   and
   B. a second polyester comprising:
i. diacid residues comprising about 90 to 100 mole percent, based on the total second polyester diacid residues, of the residues of terephthalic acid; and
ii. diol residues comprising about 5 to about 89 mole percent, based on the total second polyester diol residues, of the residues of ethylene glycol, about 10 to about 70 mole percent of the residues of 1,4-cyclohexanedimethanol residues, and about 1 to about 25 mole percent of the residues of diethylene glycol;
   wherein the polyester blend comprises about 8 to about 15 mole percent, based on the total diol residues in the polyester blend, of the residues of 1,4-cyclohexanedimethanol, and the film has about 25 to about 85 percent machine direction shrinkage and about 0 to about 10 percent transverse direction shrinkage or growth when immersed in water at 95° C. for 10 seconds.

The polyester blends encompassed by the invention are useful for the production of void-containing films in which the polymer matrix comprises a polyester blend and contains a voiding agent, dispersed therein, which compries at least one polymer incompatible with the polyester matrix. Another aspect of the present invention, therefore, is a void-containing, heat-shrinkable, polyester film comprising:
I. a polyester blend comprising

A. a first polyester comprising,
i. diacid residues comprising about 90 to 100 mole percent, based on the total first polyester diacid residues, of the residues of terephthalic acid; and
ii. diol residues comprising about 90 to 100 mole percent, based on the total first polyester diol residues, of the residues of ethylene glycol; and

B. a second polyester comprising:
i. diacid residues comprising about 90 to 100 mole percent, based on the total second polyester diacid residues, of the residues of terephthalic acid; and
ii. diol residues comprising about 5 to about 89 mole percent, based on the total second polyester diol residues, of the residues of ethylene glycol, about 10 to about 70 mole percent of the residues of 1,4-cyclohexanedimethanol residues, and about 1 to about 25 mole percent of the residues of diethylene glycol;
wherein the polyester blend comprises about 8 to about 15 mole percent, based on the total diol residues in the polyester blend, of the residues of 1,4-cyclohexanedimethanol;

and
II. a voiding agent, comprising at least one polymer incompatible with the polyester blend and dispersed therein;
   wherein the film has about 25 to about 85 percent machine direction shrinkage and about 0 to about 10 percent transverse direction shrinkage or growth when immersed in water at 95° C. for 10 seconds. The voiding agent may comprise one or more polymers. For example, the voiding agent may comprise a first polymer comprising cellulose acetate, cellulose acetate propionate, or a mixture thereof; and a second polymer comprising polystyrene, polypropylene, ethylene methyl methacrylate copolymer, or a mixture thereof.

The instant invention also provides a process for the preparation of a heat-shrinkable film, polyester film, comprising:

I. melt blending

A. a first polyester comprising:
i. diacid residues comprising about 90 to 100 mole percent, based on the total first polyester diacid residues, of the residues of terephthalic acid; and
ii. diol residues comprising about 90 to 100 mole percent, based on the total first polyester diol residues, of the residues of ethylene glycol; and

B. a second polyester comprising:
i. diacid residues comprising about 90 to 100 mole percent, based on the total second polyester diacid residues, of the residues of terephthalic acid; and
ii. diol residues comprising about 5 to about 89 mole percent, based on the total second polyester diol residues, of the residues of ethylene glycol, about 10 to about 70 mole percent of the residues of 1,4-cyclohexanedimethanol residues, and about 1 to about 25 mole percent of the residues of diethylene glycol;
to form a miscible, polyester blend comprising about 8 to about 15 mole percent, based on the total diol residues in the polyester blend, of the residues of 1,4-cyclohexanedimethanol;
   II. forming the polyester blend into a film; and
   III. stretching the film of step (II) in the machine direction,
   wherein the film has about 25 to about 85 percent machine direction shrinkage and about 0 to about 10 percent transverse direction shrinkage or growth when immersed in water at 95° C. for 10 seconds.

The heat-shrinkable films disclosed herein also may be prepared from a reactor grade polyester and are particularly useful for roll-fed or roll-applied, heat shrinkable labels. Thus, another embodiment of our invention is a heat shrinkable, roll-fed label, comprising about 60 to about 100 weight percent, based on the total weight of the label, of a reaction-grade polyester, the reaction-grade polyester comprising:
i. diacid residues comprising about 90 to 100 mole percent, based on the total diacid residues, of the residues of terephthalic acid; and
ii. diol residues comprising about 75 to about 87 mole percent ethylene glycol residues, about 8 to about 15 mole percent 1,4-cyclohexanedimethanol residues, and about 5 to about 10 mole percent diethylene glycol residues;
   wherein the roll-fed label is stretched in the machine direction at a draw ratio of about 2 to about 6 and has about 25 to about 85 percent machine direction shrinkage and 0 to about 10 percent transverse direction shrinkage or growth when immersed in water at 95° C. for 10 seconds. The roll-fed label also may comprise a voiding agent to produce void-containing, roll-fed labels.

### DETAILED DESCRIPTION

The present invention provides polyester blends that are useful for producing heat-shrinkable films. These blends comprise at least 2 different polyesters: a first polyester (A) comprising:
i. diacid residues comprising about 90 to 100 mole percent, based on the total first polyester diacid residues, of the residues of terephthalic acid; and
ii. diol residues comprising about 90 to 100 mole percent, based on the total first polyester diol residues, of the residues of ethylene glycol; and a second polyester (B) comprising:
i. diacid residues comprising about 90 to 100 mole percent, based on the total second polyester diacid residues, of the residues of terephthalic acid; and
ii. diol residues comprising about 5 to about 89 mole percent, based on the total second polyester diol residues, of the residues of ethylene glycol, about 10 to about 70 mole percent of the residues of 1,4-cyclohexanedimethanol residues, and about 1 to about 25 mole percent of the residues of diethylene glycol.
   The polyester blend, overall, comprises about 8 to about 15 mole percent, based on the total diol residues in the polyester blend, of the residues of 1,4-cyclohexanedimethanol. Shrink films prepared from these blends by uniaxial stretching in the machine direction exhibit high machine-direction shrinkage and but low transverse direction shrinkage or growth. Voiding agents may be dispersed in the blends of the invention to produce void-containing films. Our shrink film may be biaxially or uniaxially oriented and may be a single or multilayed layered. Our invention, therefore, is understood to include films in which the single layered film may be incorporated as one or more layers of a multilayered structure such as, for example, a laminate or a coextruded film. For example, the films of our invention may be used for roll-fed labels where the printed label is adhered or laminated to the container or other substrate. The heat-shrinkable films are useful for packaging applications such as, for example, labels for bottles, cans, caps, batteries, and other shrink film applications. In particular, the heat-shrinkable films prepared from our blends may be used for roll-on shrink-on (abbreviated herein as “ROSO”) label applications. The phrase “roll-on shrink-on” is intended to be synonymous with “roll applied shrink label” (“RASL”) and “wrap-around shrink label” and refers to a label produced by cutting longitudinal strips from a MDO web. These strips typically are fed from a roll, glued or laminated to the outside surface to a container or object, wrapped around the container, attached to the opposite end of the label by solvent bonding, hot-melt glue, UV-curable adhesive, radio frequency sealing, heat sealing, or ultrasonic welding, and then shrunk by exposure to heat to form a tight-fitting label that conforms to the contours of the container or object. The strips also can be formed into sleeves on mandrels and then applied to the container.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C₁ to C₅ hydrocarbons”, is intended to specifically include and disclose C₁ and C₅ hydrocarbons as well as C₂, C4, and C₄ hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

It is also to be understood that the mention of one or more method steps does not preclude the presence of additional method steps before or after the combined recited steps or intervening method steps between those steps expressly identified. Moreover, the lettering of process steps is a convenient means for identifying discrete activities or steps, and unless otherwise specified, recited process steps may be arranged in any sequence.

The term “polyester”. as used herein, is intended to include “copolyesters” and is understood to mean a synthetic polymer prepared by the polyesterificaiton and polycondensation of one or more difunctional carboxylic acids with one or more difunctional hydroxyl compounds. Typically the difunctional carboxylic acid is a dicarboxylic acid and the difunctional hydroxyl compound is a dihydric alcohol such as, for example, glycols and diols. Alternatively, the difunctional carboxylic acid may be a hydroxy carboxylic acid such as, for example, p-hydroxybenzoic acid, and the difunctional hydroxyl compound may be an aromatic nucleus bearing 2 hydroxyl substituents such as, for example, hydroquinone. The term “residue”, as used herein, means any organic structure incorporated into a polymer or plasticizer through a polycondensation reaction involving the corresponding monomer. The term “repeating unit”, as used herein, means an organic structure having a dicarboxylic acid residue and a diol residue bonded through a carbonyloxy group. Thus, the dicarboxylic acid residues may be derived from a dicarboxylic acid monomer or its associated acid halides, esters, salts, anhydrides, or mixtures thereof. As used herein, therefore, the term dicarboxylic acid is intended to include dicarboxylic acids and any derivative of a dicarboxylic acid, including its associated acid halides, esters, half-esters, salts, half-salts, anhydrides, mixed anhydrides, or mixtures thereof, useful in a polycondensation process with a diol to make a high molecular weight polyester.

The polyester blends of present invention are prepared from polyesters comprising dicarboxylic acid residues and diol residues. The polyesters of the present invention contain substantially equal molar proportions of acid residues (100 mole %) and diol residues (100 mole %) which react in substantially equal proportions such that the total moles of repeating units is equal to 100 mole %. The mole percentages provided in the present disclosure, therefore, may be based on the total moles of acid residues, the total moles of diol residues, or the total moles of repeating units. For example, a polyester containing 30 mole % isophthalic acid, based on the total acid residues, means the polyester contains 30 mole % isophthalic acid residues out of a total of 100 mole % acid residues. Thus, there are 30 moles of isophthalic acid residues among every 100 moles of acid residues. In another example, a polyester containing 30 mole % ethylene glycol, based on the total diol residues, means the polyester contains 30 mole % ethylene glycol residues out of a total of 100 mole % diol residues. Thus, there are 30 moles of ethylene glycol residues among every 100 moles of diol residues.

The polyester blends of the present invention comprise a first polyester and a different, second polyester. The term “polyester blend”, as used herein, is intended to mean a physical blend of 2 different polyesters. Typically, polyester blends are formed by blending the polyester components in the melt phase. The polyester blends of the present invention are miscible or homogeneous blends. The term “homogeneous blend”, as used herein, is synonymous with the term “miscible”, and is intended to mean that the blend has a single, homogeneous phase as indicated by a single, composition-dependent Tg. By contrast, the term “immiscible” denotes a blend that shows at least 2, randomly mixed, phases and exhibits more than one Tg. A further general description of miscible and immiscible polymer blends and the various analytical techniques for their characterization may be found in Polymer Blends Volumes 1 and 2, Edited by D. R. Paul and C. B. Bucknall, 2000, John Wiley & Sons, Inc.

The first polyester (A) of our polyester blend comprises diacid residues comprising about 90 to 100 mole percent, based on the total first polyester diacid residues, of the residues of terephthalic acid. For example, the diacid residues of the first polyester may comprise about 95 to 100 mole percent of the residues of terephthalic acid. Some additional examples of terephthalic acid residue content in the first polyester (A) are greater than about 90 mole percent, about 92 mole percent, about 95 mole percent, about 97 mole percent, and about 99 mole percent.

The diacid residues of the first polyester (A) may further comprise up to about 10 mole percent of the residues of a modifying carboxylic acid containing 4 to 40 carbon atoms if desired. For example, from 0 to about 10 mole percent of other aromatic dicarboxylic acids containing 8 to about 16 carbon atoms, cycloaliphatic dicarboxylic acids containing 8 to about 16 carbon atoms, acyclic dicarboxylic acids containing about 2 to about 16 carbon atoms, or mixtures thereof may be used. Examples of modifying carboxylic acids include, but are not limited to, at least one of malonic acid, succinic acid, glutaric acid, 1,3-cyclohexanedicarboxylic, 1,4-cyclohexanedicarboxylic acid, adipic acid, suberic acid, sebacic acid, azelaic acid, dimer acid, dodecanedioic acid, sulfoisophthalic acid, 2,6-decahydronaphthalenedicarboxylic acid, isophthalic acid, 4,4′-biphenyl-dicarboxylic, 3,3′- and 4,4-stilbenedicarboxylic acid, 4,4′-dibenzyldicarboxylic acid, or 1,4-, 1,5-, 2,3-, 2,6, and 2,7-naphthalenedicarboxylic acid. Where cis and trans isomers are possible, the pure cis or trans or a mixture of cis and trans isomers may be used.

The first polyester also comprises diol residues comprising about 90 to 100 mole percent, based on the total first polyester diol residues, of the residues of ethylene glycol. In addition to ethylene glycol, the diol residues may comprise from 0 to about 10 mole percent of the residues of at least one modifying glycol. Examples of modifying glycols include, but are not limited to, propylene glycol, 1,3-propanediol, 2,4-dimethyl-2-ethylhexane-1,3-diol, 2,2-dimethyl-1,3-propanediol, diethylene glycol, 1,4-cyclohexanedimethanol, 2-ethyl-2-butyl-1,3-propanediol, 2-ethyl-2-iso-butyl-1,3-propanediol, 1,3-butanediol, 1,4-butanediol, neopentyl glycol, 1,5-pentanediol, 1,6-hexanediol, 1,8-octanediol, 2,2,4-trimethyl-1,6-hexanediol, thiodiethanol, 1,2-cyclohexanedimethanol, 1,3-cyclohexanedimethanol, 2,2,4,4-tetramethyl-1,3-cyclo-butanediol and the like. For example, the first polyester can comprise diacid residues comprising about 95 to 100 mole percent of the residues of terephthalic acid and diol residues comprising about 90 to about 96 mole percent of the residues of ethylene glycol, about 2 to about 5 mole percent of the residues of 1,4-cyclohexanedimethanol, and about 2 to about 5 mole percent of the residues of diethylene glycol.

The first polyester may further comprise substantial amounts of recycled polyester. For example, the first polyester may comprise about 10 to about 100 weight percent of recycled polyester, based on the total weight of the first polyester (A) in the blend. The term “recycled”, as used herein, refers to scrap polyester remaining from the manufacture of shaped polyester articles such as, for example, bottles, films, containers, sheets, etc., and polyester which has been used by the consumer, disposed of, and recycled. Recycled polyester can include material that has been, for example, collected, washed, sorted, chopped, and subjected to other physical processing steps.

The polyester blend also comprises a second polyester (B) which can comprise about 90 to 100 mole percent, based on the total second polyester diacid residues, of the residues of terephthalic acid. For example, the diacid residues of the second polyester may comprise about 95 to 100 mole percent of the residues of terephthalic acid. Some additional examples of terephthalic acid residue content in the second polyester (B) are greater than about 90 mole percent, about 92 mole percent, about 95 mole percent, about 97 mole percent, and about 99 mole percent.

The diacid residues of the second polyester (B) may further comprise up to about 10 mole percent of the residues of a modifying carboxylic acid containing 4 to 40 carbon atoms if desired. For example, from 0 to about 10 mole percent of other aromatic dicarboxylic acids containing 8 to about 16 carbon atoms, cycloaliphatic dicarboxylic acids containing 8 to about 16 carbon atoms, acyclic dicarboxylic acids containing about 2 to about 16 carbon atoms or mixtures thereof may be used. Examples of modifying carboxylic acids include, but are not limited to, at least one of malonic acid, succinic acid, glutaric acid, 1,3-cyclohexanedicarboxylic, 1,4-cyclohexanedicarboxylic acid, adipic acid, suberic acid, sebacic acid, azelaic acid, dimer acid, dodecanedioic acid, sulfoisophthalic acid, 2,6-decahydronaphthalenedicarboxylic acid, isophthalic acid, 4,4′-biphenyl-dicarboxylic, 3,3′- and 4,4-stilbenedicarboxylic acid, 4,4′-dibenzyldicarboxylic acid, and 1,4-, 1,5-, 2,3-, 2,6, and 2,7-naphthalenedicarboxylic acid. Where cis and trans isomers are possible, the pure cis or trans or a mixture of cis and trans isomers may be used.

The second polyester (B) comprises diol residues that comprise about 5 to about 89 mole percent, based on the total second polyester diol residues, of the residues of ethylene glycol, about 10 to about 70 mole percent of the residues of 1,4-cyclohexanedimethanol residues, and about 1 to about 25 mole percent of the residues of diethylene glycol. The second polyester may also comprise from 0 to about 10 mole percent of at least one modifying diol. Some representative examples of modifying diols are as listed above and include propylene glycol, 1,3-propanediol, 2,4-dimethyl2-ethyl-hexanel1,3-diol, 2,2-dimethyl-1,3-propanediol, diethylene glycol, 1,4-cyclohexanedimethanol, 2-ethyl-2-butyl-1,3-propanediol, 2-ethyl-2-iso-butyl-1,3-propanediol, 1,3-butanediol, 1,4-butanediol, neopentyl glycol, 1,5-pentanediol, 1,6-hexanediol, 1,8-octanediol, 2,2,4-trimethyl-1,6-hexanediol, thiodiethanol, 1,2-cyclohexanedimethanol, 1,3-cyclohexanedimethanol, 2,2,4,4-tetra-methyl-1,3-cyclobutanediol and the like.

The amount of 1,4-cyclohexanedimethanol and diethylene glycol residues in the second polyester (B) can vary widely. Some additional examples of mole percentage ranges of the 1,4-cyclohexanedimethanol residues in the second polyesters are about 5 to about 85 mole %; about 5 to about 80 mole %; about 5 to about 75 mole %; about 5 to about 70 mole %; about 5 to about 65 mole %; about 5 to about 60 mole %; about 5 to about 55 mole %; about 5 to about 50 mole %; about 5 to about 45 mole %; about 5 to about 40 mole %; about 5 to about 35 mole %; about 10 to about 89 mole %; about 10 to about 85 mole %; about 10 to about 80 mole %; about 10 to about 75 mole %; about 10 to about 70 mole %; about 10 to about 65 mole %; about 10 to about 60 mole %; about 10 to 55 mole %; about 10 to 50 mole %; about 10 to 45 mole %; about 10 to 40 mole %; about 10 to 35 mole %; about 15 to 89 mole %; about 15 to about 85 mole %; about 15 to about 80 mole %; about 15 to about 75 mole %; about 15 to about 70 mole %; about 15 to about 65 mole %; about 15 to about 60 mole %; about 15 to about 55 mole %; about 15 to about 50 mole %; about 15 to about 45 mole %; about 15 to about 40 mole %; about 15 to about 35 mole %; about 15 to about 30 mole %; about 20 to about 89 mole %; about 20 to about 85 mole %; about 20 to about 80 mole %; about 20 to about 75 mole %; about 20 to about 70 mole %; about 20 to about 65 mole %; about 20 to about 60 mole %; about 20 to about 55 mole %; about 20 to about 50 mole %; about 20 to about 45 mole %; about 20 to about 40 mole %; about 20 to about 35 mole %; about 20 to about 30 mole %; about 25 to about 89 mole %; about 25 to about 85 mole %; about 25 to about 80 mole %; about 25 to about 70 mole %; about 25 to about 65 mole %; about 25 to about 60 mole %; about 25 to about 55 mole %; about 25 to about 50 mole %; about 25 to about 45 mole %; about 25 to about 40 mole %; about 25 to about 35 mole %; about 30 to about 89 mole %; about 30 to about 85 mole %; about 30 to about 80 mole %; about 35 to about 75 mole %; about 35 to about 70 mole %; about 35 to about 65 mole %; about 35 to about 60 mole %; about 35 to about 55 mole %; about 35 to about 50 mole %; about 40 to about 89 mole %; about 40 to about 80 mole %; about 40 to about 70 mole %; about 50 to about 89 mole %; and about 50 to about 80 mole %. Some additional examples of mole percentage ranges of the diethylene glycol residues in the second polyester (B) are about 1 to about 20 mole %; about 1 to about 15 mole %; about 1 to about 14 mole %; about 1 to about 13 mole %; about 1 to about 12 mole %; about 1 to about 11 mole %; about 1 to about 10 mole %; about 3 to about 25 mole %; about 3 to about 20 mole %; about 3 to about 15 mole %; about 3 to about 14 mole %; about 3 to about 13 mole %; about 3 to about 12 mole %; about 3 to about 11 mole %; about 3 to about 10 mole %; about 5 to about 25 mole %; about 5 to about 20 mole %; about 5 to about 15 mole %; about 5 to about 14 mole %; about 5 to about 13 mole %; about 5 to about 12 mole %; about 5 to about 11 mole %; about 5 to about 10 mole %; about 8 to about 25 mole %; about 8 to about 20 mole %; about 8 to about 15 mole %; about 8 to about 14 mole %; about 8 to about 13 mole %; about 8 to about 12 mole %; about 8 to about 11 mole %; and about 8 to about 10 mole

For example, the second polyester may comprise about 95 to 100 mole percent terephthalic acid residues, about 35 to about 89 mole percent ethylene glycol residues, and about 10 to about 40 mole percent 1,4-cyclohexanedimethanol residues, and about 1 to about 25 mole percent diethylene glycol residues. In another example, the second polyester (B) can comprise about 50 to about 77 mole percent ethylene glycol residues, about 15 to about 35 mole percent 1,4-cyclohexanedimethanol residues, and about 8 to about 15 mole percent diethylene glycol residues. Other possible combinations of mole percentage ranges for the terephthalic acid, ethylene glycol, 1,4-cyclohexanedimethanol, and diethylene glycol residues will be apparent to persons skilled in the art.

The polyester blend of our invention comprises about 8 to about 15 mole percent, based on the total diol residues in the polyester blend, of the residues of 1,4-cyclohexanedimethanol. Some additional examples of 1,4-cyclohexanedimethanol (“CHDM”) content in the polyester blend, based on the total diol residues in the polyester blend, are about 8 to 14 mole %; about 8 to 13 mole %; about 8 to 12 mole %; about 10 to 15 mole %; about 10 to 14 mole %; and about 10 to 12 mole %.

The polyesters of the present invention, the first polyester (A) and the second polyester (B), also may independently contain a branching agent. For example, the weight percent ranges for the branching agent can be about 0.01 to about 10 weight percent, or about 0.1 to about 1.0 weight percent, based on the total weight percent of polyester (A) or polyester (B). Conventional branching agents include polyfunctional acids, anhydrides, alcohols and mixtures thereof. The branching agent may be a polyol having 3 to 6 hydroxyl groups, a polycarboxylic acid having 3 or 4 carboxyl groups, or a hydroxy acid having a total of 3 to 6 hydroxyl and carboxyl groups. Examples of such compounds include trimellitic acid or anhydride, trimesic acid, pyromellitc anhydride, trimethylolethane, trimethylolpropane, a trimer acid, and the like.

The first polyester (A) and the second polyester (B) typically will have an inherent viscosity (abbreviated herein as “IV”) of about 0.4 to about 1.5 dL/g or about 0.6 to about 0.9 dL/g as measured at 25° C. using 0.50 grams of polymer per 100 ml of a solvent consisting of 60% by weight phenol and 40% by weight tetrachloroethane.

The first and second polyesters of the blend are readily prepared from the appropriate dicarboxylic acids, esters, anhydrides, or salts, and the appropriate diol or diol mixtures using typical polycondensation reaction conditions. They may be made by continuous, semi-continuous, and batch modes of operation and may utilize a variety of reactor types. Examples of suitable reactor types include, but are not limited to, stirred tank, continuous stirred tank, slurry, tubular, wiped-film, falling film, or extrusion reactors. The process is operated advantageously as a continuous process for economic reasons and to produce superior coloration of the polymer as the polyester may deteriorate in appearance if allowed to reside in a reactor at an elevated temperature for too long a duration.

The reaction of the diol and dicarboxylic acid may be carried out using conventional polyester polymerization conditions or by melt phase processes, but those with sufficient crystallinity may be made by melt phase followed by solid phase polycondensation techniques. For example, when preparing the polyester by means of an ester interchange reaction, i.e., from the ester form of the dicarboxylic acid components, the reaction process may comprise two steps. In the first step, the diol component and the dicarboxylic acid component, such as, for example, dimethyl terephthalate, are reacted at elevated temperatures, typically, about 150° C. to about 250° C. for about 0.5 to about 8 hours at pressures ranging from about 0.0 kPa gauge to about 414 kPa gauge (60 pounds per square inch, “psig”). Generally, the temperature for the ester interchange reaction ranges from about 180° C. to about 230° C. for about 1 to about 4 hours at pressure ranges from about 103 kPa gauge (15 psig) to about 276 kPa gauge (40 psig). Thereafter, the reaction product is heated under higher temperatures and under reduced pressure to form the polyester with the elimination of diol, which is readily volatilized under these conditions and removed from the system. This second step, or polycondensation step, is continued under higher vacuum and a temperature which generally ranges from about 230° C. to about 350° C. for about 0.1 to about 6 hours until a polymer having the desired degree of polymerization, as determined by inherent viscosity, is obtained. The polycondensation step may be conducted under reduced pressure which ranges from about 53 kPa (400 torr) to about 0.013 kPa (0.1 torr). Stirring or appropriate conditions are used in both stages to ensure adequate heat transfer and surface renewal of the reaction mixture. The reaction rates of both stages are increased by appropriate catalysts such as, for example, alkoxy titanium compounds, alkali metal hydroxides and alcoholates, salts of organic carboxylic acids, alkyl tin compounds, metal oxides, and the like. A three-stage manufacturing procedure, similar to that described in U.S. Pat. No. 5,290,631, may also be used, particularly when a mixed monomer feed of acids and esters is employed.

The amounts of each of the first and second polyesters in the blend typically will range from about 30 to about 70 weight percent, based on the total weight of the blend. For example, the polyester blend may comprise about 40 to about 60 weight percent of the first polyester (A) and about 60 to about 40 weight percent of the second polyester (B). Other weight percentage ranges for each of the first and second polyesters are about 45 to about 55 weight percent and about 50 weight percent. For example, the polyester blend may comprise about 40 to about 60 weight percent of a first polyester (A), comprising about 90 to 100 mole percent of the residues of terephthalic acid, about 2 to about 5 mole percent of the residues of 1,4-cyclohexanedimethanol, and about 2 to about 5 mole percent of the residues of diethylene glycol; and about 60 to about 40 weight percent of a second polyester (B), comprising about 50 to about 77 mole percent ethylene glycol residues, about 15 to about 35 mole percent 1,4-cyclohexanedimethanol residues, and about 8 to about 15 mole percent diethylene glycol residues. In another example, the blend comprises about 50 weight percent of the first polyester (A) and about 50 weight percent of the second polyester (B). Persons having ordinary skill in the art will recognize that the polyester blend of the instant invention can comprise any of the compositions described hereinabove for the first and second polyesters, which may in turn be combined in any of the above weight percentages.

The polyester blend may be prepared by melt blending or compounding the first and second polyester components according to methods well known to persons skilled in the art. The term “melt” as used herein includes, but is not limited to, merely softening the polymers. Typically, the melt blending method includes blending the polymers at a temperature sufficient to melt the first and second polyesters. The melt blending procedure may be performed in an agitated, heated vessels such as, for example, an extruder. The blend may be cooled and pelletized for further use or the melt blend can be processed directly from this molten blend into film or other shaped article by extrusion, calendering, thermoforming, blow-molding, extrusion blow-molding, injection molding, compression molding, casting, drafting, tentering, or blowing. For example, the first and second polyesters, typically in pellet form, may be mixed together by weight in a tumbler and then placed in a hopper of an extruder for melt compounding. Alternatively, the pellets may be added to the hopper of an extruder by various feeders which meter the pellets in their desired weight ratios. Upon exiting the extruder the now homogeneous polyester blend is shaped into a film. The shape of the film is not restricted in any way. Examples of melt mixing methods generally known in the polymers art are described in Mixing and Compounding of Polymers (I. Manas-Zloczower & Z. Tadmor eds., Carl Hanser Verlag publisher, N.Y. 1994).

The polyester blend may further comprise one or more antioxidants, melt strength enhancers, chain extenders, flame retardants, fillers, acid scavengers, dyes, colorants, pigments, antiblocking agents, flow enhancers, impact modifiers, antistatic agents, processing aids, mold release additives, plasticizers, slip agents, stabilizers, waxes, UV absorbers, optical brighteners, lubricants, pinning additives, foaming agents, antistats, nucleators, glass beads, metal spheres, ceramic beads, carbon black, crosslinked polystyrene beads, and the like. Colorants, sometimes referred to as toners, may be added to impart a desired neutral hue and/or brightness to the polyester and the calendered product. For example, the polyester blend may comprise 0 to about 30 weight percent of one or more processing aids to alter the surface properties of the composition and/or to enhance flow. Representative examples of processing aids include calcium carbonate, talc, clay, mica, zeolites, wollastonite, kaolin, diatomaceous earth, TiO₂, NH₄Cl, silica, calcium oxide, sodium sulfate, and calcium phosphate. Use of titanium dioxide and other pigments or dyes, might be included, for example, to control whiteness of films produced from the blend, or to make a colored film.

Our invention also provides a heat-shrinkable film prepared from the polyester blends described hereinabove. Therefore, another aspect of the present invention is heat shrinkable, polyester film comprising a polyester blend, the polyester blend comprising:

A. a first polyester comprising:
i. diacid residues comprising about 90 to 100 mole percent, based on the total first polyester diacid residues, of the residues of terephthalic acid; and
ii. diol residues comprising about 90 to 100 mole percent, based on the total first polyester diol residues, of the residues of ethylene glycol; and
   B. a second polyester comprising:
i. diacid residues comprising about 90 to 100 mole percent, based on the total second polyester diacid residues, of the residues of terephthalic acid; and
ii. diol residues comprising about 5 to about 89 mole percent, based on the total second polyester diol residues, of the residues of ethylene glycol, about 10 to about 70 mole percent of the residues of 1,4-cyclohexanedimethanol residues, and about 1 to about 25 mole percent of the residues of diethylene glycol;
   wherein the polyester blend comprises about 8 to about 15 mole percent, based on the total diol residues in the polyester blend, of the residues of 1,4-cyclohexanedimethanol, and the film has about 25 to about 85 percent machine direction shrinkage and about 0 to about 10 percent transverse direction shrinkage or growth when immersed in water at 95° C. for 10 seconds. It should be understood that the heat-shrinkable polyester film includes the various embodiments of the polyester blend, first polyester, and second polyester as described hereinabove.

For example, the diacid residues of the first polyester may comprise about 95 to 100 mole percent of the residues of terephthalic acid. Some additional examples of terephthalic acid residue content in the first polyester (A) are greater than about 90 mole percent, about 92 mole percent, about 95 mole percent, about 97 mole percent, and about 99 mole percent.

As described previously, the first polyester also may comprise diol residues comprising about 90 to 100 mole percent, based on the total first polyester diol residues, of the residues of ethylene glycol. For example, the first polyester can comprise diacid residues comprising about 95 to 100 mole percent of the residues of terephthalic acid and diol residues comprising about 90 to about 96 mole percent of the residues of ethylene glycol, about 2 to about 5 mole percent of the residues of 1,4-cyclohexanedimethanol, and about 2 to about 5 mole percent of the residues of diethylene glycol.

The first polyester also may further comprise substantial amounts of recycled polyester. For example, the first polyester may comprise about 10 to about 100 weight percent of recycled polyester, based on the total weight of the first polyester (A) in the blend.

The second polyester (B) can comprise about 90 to 100 mole percent, based on the total second polyester diacid residues, of the residues of terephthalic acid; about 5 to about 89 mole percent, based on the total second polyester diol residues, of the residues of ethylene glycol, about 10 to about 70 mole percent of the residues of 1,4-cyclohexanedimethanol residues, and about 1 to about 25 mole percent of the residues of diethylene glycol. For example, the diacid residues of the second polyester may comprise about 95 to 100 mole percent of the residues of terephthalic acid. Some additional examples of terephthalic acid residue content in the second polyester (B) are greater than about 90 mole percent, about 92 mole percent, about 95 mole percent, about 97 mole percent, and about 99 mole percent.

In another example, second polyester (B) may comprise about 95 to 100 mole percent terephthalic acid residues, about 35 to about 89 mole percent ethylene glycol residues, and about 10 to about 40 mole percent 1,4-cyclohexanedimethanol residues, and about 1 to about 25 mole percent diethylene glycol residues. In another example, the second polyester (B) may comprise about 50 to about 77 mole percent ethylene glycol residues, about 15 to about 35 mole percent 1,4-cyclohexanedimethanol residues, and about 8 to about 15 mole percent diethylene glycol residues. Other possible concentrations of 1,4-cyclohexanedimethanol and diethylene glycol residues in the second polyester are as described previously.

The polyester blend of the heat-shrinkable film, as described hereinabove, typically will comprise about 30 to about 70 weight percent, based on the total weight of the blend of the first and second polyesters (A) and (B). For example, the polyester blend may comprise about 40 to about 60 weight percent of the first polyester (A) and about 60 to about 40 weight percent of the second polyester (B). Other weight percentage ranges for each of the first and second polyesters are about 45 to about 55 weight percent and about 50 weight percent. For example, the polyester blend may comprise about 40 to about 60 weight percent of a first polyester (A), comprising about 90 to 100 mole percent of the residues of terephthalic acid, about 2 to about 5 mole percent of the residues of 1,4-cyclohexanedimethanol, and about 2 to about 5 mole percent of the residues of diethylene glycol; and about 60 to about 40 weight percent of a second polyester (B), comprising about 50 to about 77 mole percent ethylene glycol residues, about 15 to about 35 mole percent 1,4-cyclohexanedimethanol residues, and about 8 to about 15 mole percent diethylene glycol residues. For example, the blend comprises about 50 weight percent of the first polyester (A) and about 50 weight percent of the second polyester (B) described above. Other weight percentages of the first and second polyester can be combined with the various compositions of the polyesters described above.

The heat-shrinkable films, typically, may be prepared by methods well-known to persons skilled in the art such as, for example, extrusion, calendering, casting, drafting, tentering, or blowing. These methods initially create an unoriented or “cast” film that is subsequently stretched in at least one direction to impart orientation. The term “oriented”, as used herein, means that the polyester film is stretched to impart direction or orientation in the polymer chains. The polyester film, thus, may be “uniaxially stretched”, meaning the polymer matrix is stretched in one direction or “biaxially stretched,” meaning the polymer matrix has been stretched in two different directions. Typically, but not always, the two directions are substantially perpendicular. For example, in the case of a film, the two directions are in the longitudinal or machine direction (“MD”) of the film (the direction in which the film is produced on a film-making machine) and the transverse direction (“TD”) of the film (the direction perpendicular to the MD of the film). Biaxially stretched articles may be sequentially stretched, simultaneously stretched, or stretched by some combination of simultaneous and sequential stretching. In generally, stretch or draw ratios of about 3× to about 8× are imparted in one or more directions to create uniaxially or biaxially oriented films. The phrases “stretch ratio” and “draw ratio”, are intended to be synonymous and refer to the length of the stretched film divided by the length of the unstretched film. For example, “machine direction draw ratio” or “MD draw ratio” refers to the draw ratio in the machine direction. Similarly, “TD draw ratio” refers to the draw ratio in the transverse direction. More typically, stretch ratios are from 4× to about 6×. The stretching can be performed, for example, using a double-bubble blown film tower, a tenter frame, or a machine direction drafter. Stretching is generally performed at or near the glass transition temperature (Tg) of the polymer. For polyesters, for example, this range is typically Tg+5° C. (Tg+10° F.) to about Tg+33° C. (Tg+60° F.), although the range may vary slightly depending on additives. A lower stretch temperature will impart more orientation with less relaxation (and hence more shrinkage), but may increase film tearing. To balance these effects, an optimum temperature in the mid-range is often chosen.

For example, the heat-shrinkable film may be stretched in the machine direction (MD) at a draw ratio of about 2 to about 7; about 2 to about 6; about 3 to about 7; about 3 to about 6; about 4 to about 7; or about 4 to about 6. Typically, in stretching the film, it may be initially heated to a temperature above its glass transition temperature. For example, the film may be heated in the range of a glass transition temperature (Tg) of the polyester blend composition of from Tg to Tg+80° C.; Tg to Tg+60° C.; Tg to Tg+40° C.; Tg to Tg+5° C.; or Tg+10° C. to Tg+20° C. The film then may be stretched at of rate of about 10 to 300 meters per minute.

The heat-shrinkable film may be uniaxially oriented, meaning that the processing history may include stretching in the machine direction without stretching in the transverse direction. Alternatively, the heat-shrinkable film processing history may include additional stretching, either simultaneously or sequentially, in the transverse direction at a draw ratio of less than about 1.1, about 1.2, about 1.5, or about 2.0. For example, the heat-shrinkable may be stretched in the machine direction at a draw ratio of about 2 to about 6 and in the transverse direction at a draw ratio 0 to about 2.

Post-stretch annealing or heatsetting may be used to adjust shrink properties of the film, although annealing the film under tension can cause an increase in TD growth due to additional neck-in. Annealing times and temperatures will vary from machine to machine and with each formulation, but typically will range from about Tg to about Tg+50° C. for about 1 to about 15 seconds. Higher temperatures usually require shorter annealing times and are preferred for higher line speeds. The annealing process typically will reduce the MD shrinkage accordingly. Generally, to avoid additional neck-in and TD growth, annealing should be carried out while the film is under low tension. For example, in one embodiment, annealing is carried out under conditions that maintain post-stretch, total neck-in of the film web to 0.5% or less.

When stretched, the heat shrinkable films of the invention typically show a stress-induced, increase in crystallinity over the unstretched film of 0 to about 30 percent as measured by differential scanning calorimetry according methods well known in the art. Other examples of stress induced crystallinity are about 5 to about 30 percent, about 10 to about 30 percent, about 11 to about 30 percent, about 12 to about 30 percent, about 15 to about 30 percent, about 18 to about 30 percent, and about 20 to about 30%. While not being bound by theory, it is believed that this increase in crystallinity induced by stretching is related to the low transverse growth or shrinkage exhibited by all of the films of the invention. Thus, it can be advantageous to stretch the film sufficiently to produce a film having adequate crystallinity to maintain TD growth or shrinkage at 0 to about 10 percent. In one embodiment of our invention, the heat shrinkable films of the invention are stretched in the machine direction to give a percent crystallinity of about 10 to about 30%. Other embodiments of the invention include stretching the film in the machine direction to give a percent crystallinity of about 11 to about 30%, about 12 to about 30%, about 13 to about 30%, about 14 to about 30%, about 15 to about 30%, about 16 to about 30%, about 17 to about 30%, about 18 to about 30%, about 19 to about 30%, about 20 to about 30%, about 22 to about 30%, and about 25 to about 30%.

Our heat-shrinkable film can have about 25 to about 85 percent machine direction shrinkage and about 0 to about 10 percent transverse direction shrinkage or growth when immersed in water at 95° C. for 10 seconds. The phrase “TD growth or shrinkage”, as used herein, is intended to mean TD growth or shrinkage as measured the drive side, center, or operator side of the film web. For example, if any section of film exhibits TD growth or shrinkage exceeding about 10%, then that film would be considered to have a TD growth or shrinkage greater than 10%, even if other sections of the film web exhibited less than 10% growth or shrinkage. Some additional examples of MD shrinkage that can characterize the heat-shrinkable film include about 25 to about 80%; about 25 to about 75%; about 25 to about 70%; about 25 to about 65%; about 25 to about 60%; about 25 to about 50%; about 25 to about 45%; about 25 to about 40%; about 30 to about 85%; about 30 to about 80%; about 30 to about 75%; about 30 to about 70%; about 30 to about 65%; about 30 to about 60%; about 30 to about 55%; about 30 to about 50%; about 35 to about 85%; about 35 to about 80%; about 35 to about 75%; about 35 to about 70%; about 35 to about 65%; about 35 to about 60%; about 35 to about 55%; about 35 to about 50%; about 40 to about 85%; about 40 to about 80%; about 40 to about 75%; about 40 to about 70%; about 40 to about 65%; about 40 to about 60%; about 40 to about 55%; about 40 to about 50%; about 45 to about 85%; about 45 to about 80%; about 45 to about 75%; about 45 to about 70%; about 45 to about 65%; about 45 to about 60%; about 45 to about 55%; about 50 to about 85%; about 50 to about 80%; about 50 to about 75%; about 50 to about 70%; about or 50 to about 60%. In addition, the heat-shrinkable film may have about 0 to about 4, 0 to about 5, 0 to about 6, 0 to about 7, 0 to about 8, or 0 to about 10 percent transverse direction shrinkage or growth.

The heat-shrinkable films described herein typically show low variability in the TD shrinkage across the width of the web. The term “web”, as used herein, is well understood by persons skilled in the art and refers to a strip of continuous film processed on a stretching apparatus. Typically, the length of a web (i.e., in the longitudinal direction) is much greater that its width (i.e., transverse or perpendicular direction). The variability in TD shrinkage or growth across a web may be less than plus or minus about 10, about 8, about 5, about 3, or about 2 percentage points. A specific illustration would be a web with three 100 mm by 100 mm samples taken: sample 1 from the operator side, sample 2 from the center, and sample 3 from drive side of a web. If samples 1, 2, and 3 had a TD growth of −5%, −3%, and −7%, respectively, the variability in TD shrinkage or growth across the web would be 4 percentage points. The variability is reported as the number of percentage points between the largest TD growth, −7% on the drive side, and the smallest TD growth, −3% in the center. In a second example, if samples 1, 2, and 3 had a TD shrinkage of −1%, 0, and +2% (i.e., the first sample grew and the last sample shrunk), the variability of TD shrinkage or growth would be 3 percentage points as the difference between 2 percent shrinkage and 1 percent growth is 3 percentage points.

The variability in TD shrinkage and, specifically, the phenomenon of TD growth, in labels cut from the edges of the web is caused by neck-in. The term “neck-in” refers to the decrease in width experienced by a web as it is stretched in the machine direction. Neck-in is equal to the web width before stretching minus the web width post stretching, divided by the web width before stretching. The percent neck-in is the calculated neck-in times 100. The term “normalized neck-in”, as used herein, is understood by persons skilled in the art to mean the percent neck-in divided by the draw ratio. As a web typically decreases in width with increased draw ratio, the normalized neck-in is a better indication of the impact that composition and other properties may have on the neck-in phenomenon. Neck-in occurs when the web is stretched in the machine direction. The stresses in the machine direction coupled with lack of support at the web edges cause the width of the web to decrease. For example, the normalized neck-in may be less than about 8, about 6, about 5, about 4, about 3, or about 2 percent.

In another example, the MD shrinkage of the heat-shrinkable film, for an essentially constant composition and draw ratio, may increase from by about 5 to about 30 percentage points; about 5 to about 25 percentage points; about 5 to about 20 percentage points; about 5 to about 15 percentage points; about 10 to about 30 percentage points; about 10 to about 25 percentage points; or about 10 to about 20 percentage points as the number of stretching stations increases from 1 to 10; 1 to 8; 1 to 6; 1 to 4; 1 to 3; or 1 to 2. An essentially constant composition takes into account normal manufacturing variability in a blend composition due to normal variability in the composition of each polyester used to make the blend and the normal variability in weight percentage of each polyester during blending. Also, an essentially constant draw ratio takes into account normal manufacturing variability, for example, when the rolls of a stretching line have particular rotation rate set to maintain a specified draw ratio. The number of stretching stations depends upon the friction ratio, or speed ratio, between adjacent sets of rolls. The number of stretching stations is equal to the number of adjacent pairs of draw rolls with friction ratios above one. For example, on a stretching apparatus with four sets of draw rolls, D1, D2, D3, and D4, with friction ratios of D2/D1=5, D3/D2=1, and D4/D3=1, then one stretching station would be used to achieve the draw ratio of 5. If the friction ratios were D2/D1=2.24, D3/D2=2.24 and D4/D3=1, then two stretching stations would be used to achieve the draw ratio of 5. In another example, if the friction ratios were D2/D1=1.71, D3/D2=1.71 and D4/D3=1.71, then three stretching stations would be used to achieve the draw ratio of 5.

Sleeves and labels may be prepared from the heat-shrinkable film of the present invention according to methods well known in the art. These sleeves and labels are useful for packaging applications such as, for example, labels for plastic bottles comprising poly(ethylene terephthalate). Our invention, therefore, provides a sleeve or roll-fed label comprising the heat-shrinkable films described hereinabove. These sleeves and labels may be conveniently seamed by methods well-known in the art such as, for example, by solvent bonding, hot-melt adhesives, UV-curable adhesives, radio frequency sealing, heat sealing, or ultrasonic bonding. For traditional shrink sleeves involving transverse oriented film (via tentering or double bubble), the label is first printed and then seamed along one edge to make a tube. Solvent seaming can be performed using any of a number of solvents or solvent combinations known in the art such as, for example, THF, dioxylane, acetone, cyclohexanone, methylene chloride, n-methyl-pyrrolidone, and MEK. These solvents have solubility parameters close to that of the film and serve to dissolve the film sufficiently for welding. Other methods such as RF sealing, adhesive gluing, UV curable adhesives, and ultrasonic bonding can also be applied. The resulting seamed tube is then cut and applied over the bottle prior to shrinking in a steam, infrared or hot air type tunnel. During the application of the sleeve with certain types of sleeving equipment, it is important that the film have enough stiffness to pass over the bottle without crushing or collapsing as the sleeve tends to stick to or “grab” against the side of the bottle because of friction.

For roll-fed labels, the heat-shrinkable film traditionally is oriented in the machine direction using, for example, a drafter. These labels are wrapped around the bottle and, typically, glued in place online. As production line speeds increase, however, faster seaming methods are needed, and UV curable, RF sealable, and hot melt adhesives are typically employed over solvent seaming. For example, hot melt polyesters may be used to seam the present heat-shrinkable film.

Voiding agents may be dispersed within the polyester blend to produce a void-containing film when the film is stretched or oriented. Another aspect of our invention, therefore, is a void-containing, heat shrinkable, polyester film, comprising:
I. a polyester blend comprising:

A. a first polyester comprising,
i. diacid residues comprising about 90 to 100 mole percent, based on the total first polyester diacid residues, of the residues of terephthalic acid; and
ii. diol residues comprising about 90 to 100 mole percent, based on the total first polyester diol residues, of the residues of ethylene glycol;
and

B. a second polyester comprising:
i. diacid residues comprising about 90 to 100 mole percent, based on the total second polyester diacid residues, of the residues of terephthalic acid; and
ii. diol residues comprising about 5 to about 89 mole percent, based on the total second polyester diol residues, of the residues of ethylene glycol, about 10 to about 70 mole percent of the residues of 1,4-cyclohexanedimethanol residues, and about 1 to about 25 mole percent of the residues of diethylene glycol;
wherein the polyester blend comprises about 8 to about 15 mole percent, based on the total diol residues in the polyester blend, of the residues of 1,4-cyclo-hexanedimethanol; and
II. a voiding agent, comprising at least one polymer incompatible with the polyester blend and dispersed therein;
   wherein the film has about 25 to about 85 percent machine direction shrinkage and about 0 to about 10 percent transverse direction shrinkage or growth when immersed in water at 95° C. for 10 seconds. Persons skilled in the art will understand that the above void-containing film can incorporate all of the various embodiments of the first polyester (A), second polyester (B), the polyester blend, and heat-shrinkable film described hereinabove including, but not limited to, compositions, additives, applications, preparation, and shrinkage properties of the film.

The terms “voids”, “microvoids”, and “micropores”, as used herein, are intended to be synonymous and are well-understood by persons skilled in the art to mean tiny, discrete voids or pores contained within the polyester below the surface of the article that are intentionally created during the manufacture of the article. Similarly, the terms “voided”, “microvoided”, “cavitated” and “void-containing”. as used herein in reference to the compositions, polymers, and films of the invention, are intended to be synonymous and mean “containing tiny, discrete voids or pores”. The films of the invention include a “voiding agent” dispersed within the polyester matrix. The term “voiding agent”, as used herein, is synonymous with the terms “voiding composition”, “microvoiding agent”, and “cavitation agent” and is understood to mean a substance dispersed within a polymer matrix that is useful to bring about or cause the formation voids within the polymer matrix” upon orientation or stretching of the polymer matrix. The term “polymer matrix”, as used herein, is synonymous with the term “matrix polymer” and refers to the polyester or polyester blend that provides a continuous phase in which the voiding again may be dispersed such that the particles of the voiding agent are surrounded and contained by the continuous phase.

To generate voids efficiently within the polyester matrix, it is desirable that the voiding agent have a hardness that is greater than the polyester blend at the stretch temperature of the film. Typical voiding agents which may be used with polyesters include at least one polymer selected from cellulosic polymers, starch, esterified starch, polyketones, polyester, polyamides, polysulfones, polyimides, polycarbonates, olefinic polymers, and copolymers thereof. The term “olefinic polymer”, as used herein is intended to mean a polymer resulting from the addition polymerization of ethylenically unsaturated monomers such as, for example, polyethylene, polypropylene, polystyrene, poly(acrylonitrile), poly(acrylamide), acrylic polymers, poly(vinyl acetate), poly(vinyl chloride), and copolymers of these polymers. The voiding agent may also comprise one or more inorganic compounds such as, for example talc, silicon dioxide, titanium dioxide, calcium carbonate, barium sulfate, kaolin, wollastonite, and mica. The voiding agent also may comprise a combination of polymeric and inorganic materials. The shrink film forms voids on orientation or stretching at a temperature at or above the Tg of the polyester matrix. Stretching may be carried out in one or more directions at a stretch or draw ratio of at least 1.5. Thus, as described previously, the composition may be “uniaxially stretched”, meaning the polyester is stretched in one direction or “biaxially stretched,” meaning the polyester is stretched in two different directions.

The voiding agent may comprise one or more polymers. The voiding agent may be a single polymer or blend of one or more polymers. For example, the voiding agent may comprise at least one polymer selected from cellulosic polymers, starch, esterified starch, polyketones, fluoropolymers, polyacetals, polyesters, polyamides, polysulfones, polyimides, polycarbonates, olefinic polymers, and copolymers of these polymers with other monomers such as, for example, copolymers of ethylene with acrylic acid and its esters. Cellulosic polymers are particularly efficient voiding agents. For example, the voiding agent may comprise a first polymer comprising at least one cellulosic polymer comprising one or more of microcrystalline cellulose, a cellulose ester, or a cellulose ether. In another example, the first polymer may be a cellulose ester such as, for example, cellulose acetate, cellulose triacetate, cellulose acetate propionate, or cellulose acetate butyrate. In yet another example, the first polymer may be a cellulose ether which may include, but is not limited to, one or more of hydroxypropyl cellulose, methyl ethyl cellulose, or carboxymethyl cellulose.

The voiding agent also may comprise a second polymer comprising one or more polymers selected from polyamides, polyketones, polysulfones, fluoropolymers, polyacetals, polyesters, polycarbonates, olefinic polymers, or copolymers thereof. For example, the second polymer may include, but is not limited to, one or more olefinic polymers such as, for example, polyethylene, polystyrene, polypropylene, and copolymers thereof. Further non-limiting examples of olefinic copolymers include ethylene vinyl acetate, ethylene vinyl alcohol copolymer, ethylene methyl acrylate copolymer, ethylene butyl acrylate copolymer, ethylene acrylic acid copolymer, ionomer, or mixtures thereof. We have found that olefinic copolymers such as, for example, ethylene methyl acrylate copolymer (abbreviated herein as “EMAC”), ethylene butyl acrylate (abbreviated herein as “EBAC”), ethylene acrylic acid (abbreviated herein as “EAA”) copolymer, maleated, oxidized or carbyoxylated PE, and ionomers may be used advantageously with the cellulosic polymers described above as the second polymer to increase the opacity and improve the overall aesthetics and feel of the film. These olefinic polymers also may aid the compounding and dispersion of the cellulosic. Thus, for example, the second polymer may comprise one or more of EMAC or EBAC. In another embodiment, for example, the voiding agent can comprise a first polymer comprising cellulose acetate, cellulose triacetate, cellulose acetate proprionate, cellulose acetate butyrate, hydroxypropyl cellulose, methyl ethyl cellulose, carboxymethyl cellulose, or mixtures thereof; and a second polymer comprising polyethylene, polystyrene, polypropylene, ethylene vinyl acetate, ethylene vinyl alcohol copolymer, ethylene methyl acrylate copolymer, ethylene butyl acrylate copolymer, ethylene acrylic acid copolymer, ionomer, or mixtures thereof. In another example, the first polymer may comprise one or more of cellulose acetate or cellulose acetate propionate and the second polymer may comprise polystyrene, polypropylene, ethylene methyl acrylate copolymer, or a mixture thereof. In yet another example, the first polymer comprises cellulose acetate, the second polymer comprises polypropylene and ethylene methyl acrylate copolymer.

The polymers that may be used as the first polymer or second polymer, of the voiding agent may be prepared according to methods well-known in the art or obtained commercially. Examples of commercially available polymers which may be used in the invention include EASTAR™, EASTAPAK™, SPECTAR™, and EMBRACE™ polyesters and copolyesters available from Eastman Chemical Co,; LUCITE™ acrylics available from Dupont; TENITE™ cellulose esters available from Eastman Chemical Co.; LEXAN™ (available from GE Plastics) or MAKROLON™ (available from Bayer) polycarbonates; DELRIN™ polyacetals available from Dupont; K-RESIN™ (available from Phillips) and FINACLEAR™/FINACRYSTAL™ (available from Atofina) styrenics and styrenic copolymers; FINATHENE™ (available from Atofina) and HIFOR™/TENITE™ (available from Eastman) polyethylenes; ZYTEL™ nylons available from Dupont; ULTRAPEK™ PEEK available from BASF; KAPTON™ polyimides available from Dupont; and TEDLAR™ and KYNAR™ fluoropolymers available from Dupont and Atofina, respectively.

The void-containing film will generally contain about 1 to about 40 weight percent of voiding agent, based on the total weight of the film. Other examples of voiding agent content within the film are about 5 to about 35 weight percent, about 10 to about 35 weight percent, about 15 to about 35 weight percent, and about 15 to about 30 weight percent. Typically, the voiding agent comprises about 5 to about 95 weight percent of the first polymer, based on the total weight of the voiding agent. Other weight percent ranges for the first polymer within the voiding agent are about 30 to about 60 weight percent and about 50 to about 60 weight percent. When the voiding agent comprises a cellulosic polymer and an olefinic polymer, the voiding agent typically will comprise at least 5 weight percent or more of the cellulosic polymer, based on the total weight of the composition. For example, the voiding agent may comprise at least 30 weight percent of the cellulosic polymer. The components of the voiding agent may be compounded together on a mixing device such as, for example, a twin screw extruder, planetary mixer, or Banbury mixer, or the components may be added separately during film formation. Small amounts of inorganic voiding agents may also be included. It may be desirable to precompound the cellulosic polymer and the olefin, in which the olefin may be used as part of the carrier resin in which the cellulosic is dispersed. Precompounding the olefin and the cellulosic polymer provides the added advantage that the olefin serves as a vehicle for dispersing the cellulosic polymer, and provides an efficient moisture barrier to prevent uptake of moisture into the cellulosic polymer prior to final extrusion. In addition, the voiding agent is easier to handle and dry. It is also possible to use blends of polymers as voiding agents as long as sufficient shearing, for example, by the use of a twin screw or high shear single screw extruder, is used to adequately disperse the components of the voiding agent.

The formation of the sheet or film may be carried as described previously by any method known to persons having ordinary skill in the art such as, for example, by extrusion, calendering, casting, or blowing. The voiding agent and the polyester may be dry blended or melt mixed at a temperature at or above the Tg of the polyester in a single or twin screw extruder, roll mill or in a Banbury Mixer to form a uniform dispersion of the voiding agent in the polyester. In a typical procedure for preparing film such as, for example, using a voiding agent comprising a cellulosic polymer and an olefin, and a reactor-grade polyester or polyester blend as the polymer matrix, the melt is extruded through a slotted die using melt temperatures in the range of about 200° C. (400° F.) to about 280° C. (540° F.) and cast onto a chill roll maintained at about −1° C. (30° F.) to about 82° C. (180° F.). The film or sheet thus formed will generally have a thickness of about 5 to about 50 mils, although a more typical range is 5 to 15 mils. The film or sheet is then uniaxally or biaxially stretched in amounts ranging from about 200 to about 700% to provide an oriented film having a thickness of about 1 to about 10 mils, more typically about 1 to about 3 mils. Higher final thicknesses might be desirable, for example, to take advantage of the insulative properties or cushioning properties of the void-containing film. The voids created during the stretching operation can act as insulators much like the pores of a foamed film. Thus, the thickness of the film can be increased as appropriate to achieve the desired level of insulation. It is also possible to combine void-containing layers with foamed layers in a layered or laminated structure. For example, a foamed center layer can be encapsulated by two void-containing layers to maximize density reduction and improve printing performance.

The stretching processes may be done in line or in subsequent operations as described previously. For the shrink film of the present invention, the film typically is not heatset significantly to provide maximum shrinkage. Subsequently, the void-containing film may be printed and used, for example, as labels on beverage or food containers. Because of the presence of voids, the density of the film is reduced and the effective surface tension of the film is increased giving it a more paper-like texture. Accordingly, the film will readily accept most printing inks and, hence, may be considered a “synthetic paper”. Our shrink film may also be used as part of a multilayer or coextruded film, or as a component of a laminated article.

Post-stretch annealing or heatsetting is also advantageous for maintaining low density and reducing shrink force. High shrink stresses may cause the film to shrink prematurely and may close some of the voids thereby offsetting any density reduction. Annealing times and temperatures will vary from machine to machine and with each formulation, but typically will range from about Tg to about Tg+50° C. for about 1 to about 15 seconds. Higher temperatures usually require shorter annealing times and are preferred for higher line speeds. Additional stretching after annealing can be performed, although not required. The annealing process typically will reduce the maximum shrinkage slightly (e.g. a few percent); however reduction is sometimes useful to maintain the void cells and to maintain the dimensions of the film. Generally, to avoid addition neck-in and TD growth, it can be advantages to carry out annealing procedures while the film is under low tension. Typically, annealing should be carried out under conditions that maintain post-stretch, total neck-in to 0.5% or less.

The heat-shrinkable void containing film may be used to prepare sleeve or roll-fed labels as described previously. Because of the low transverse shrinkage or growth, the heat-shrinkable and void-containing films are particularly suited for the preparation of roll-fed, shrink-on labels commonly used for drink bottles and other containers.

The present invention also provides a process for the preparation of a heat-shrinkable polyester film from the polyester blends described herein Thus, another embodiment of our invention is a process for the preparation of a heat shrinkable, polyester, film comprising:

I. melt blending

A. a first polyester comprising:
i. diacid residues comprising about 90 to 100 mole percent, based on the total first polyester diacid residues, of the residues of terephthalic acid; and
ii. diol residues comprising about 90 to 100 mole percent, based on the total first polyester diol residues, of the residues of ethylene glycol; and

B. a second polyester comprising:
i. diacid residues comprising about 90 to 100 mole percent, based on the total second polyester diacid residues, of the residues of terephthalic acid; and
ii. diol residues comprising about 5 to about 89 mole percent, based on the total second polyester diol residues, of the residues of ethylene glycol, about 10 to about 70 mole percent of the residues of 1,4-cyclohexanedimethanol residues, and about 1 to about 25 mole percent of the residues of diethylene glycol;
to form a miscible, polyester blend comprising about 8 to about 15 mole percent, based on the total diol residues in the polyester blend, of the residues of 1,4-cyclo-hexanedimethanol;
   II. forming the polyester blend into a film; and
   III. stretching the film of step (II) in the machine direction,
   wherein the film has about 25 to about 85 percent machine direction shrinkage and about 0 to about 10 percent transverse direction shrinkage or growth when immersed in water at 95° C. for 10 seconds. The various embodiments of the first polyester (A), second polyester (B), the polyester blend, and film properties are as described previously.

Our invention also includes heat shrinkable, roll-fed label, prepared from a reactor grade polyester having an overall composition similar to that of the polyester blends described hereinabove. Another embodiment of our invention, therefore, is a heat-shrinkable, roll-fed label comprising about 60 to about 100 weight percent, based on the total weight of the label, of a reactor-grade polyester, the reaction-grade polyester comprising:
i. diacid residues comprising about 90 to 100 mole percent, based on the total diacid residues, of the residues of terephthalic acid; and
ii. diol residues comprising about 75 to about 87 mole percent ethylene glycol residues, about 8 to about 15 mole percent 1,4-cyclohexanedimethanol residues, and about 5 to about 10 mole percent diethylene glycol residues;
   wherein the roll-fed label is stretched in the machine direction at a draw ratio from about 2 to about 6 and has about 25 to about 85 percent machine direction shrinkage and 0 to about 10 percent transverse direction shrinkage or growth when immersed in water at 95° C. for 10 seconds.

The term “reactor grade” polyester, as used herein, is understood to mean a random, polyester produced by the transesterification and polycondensation of monomers in one or more reactors, as is well-known and understood by persons skilled in the art. Typically, reactor grade polyesters are prepared by the polyesterification of dicarboxylic acids and diols and provide more consistent properties than polyester blends.

The roll-fed labels comprise a reactor grade polyester that comprises about 90 to 100 mole percent terephthalic acid residues, based on the total diacid residues. The polyester may contain other amounts of terephthalic acid. For example, the diacid residues of the first polyester may comprise about 95 to 100 mole percent of the residues of terephthalic acid. Some additional examples of terephthalic acid residue content in the first polyester (A) are greater than about 90 mole percent, about 92 mole percent, about 95 mole percent, about 97 mole percent, and about 99 mole percent. The diacid residues may comprise minor amounts, e.g., from 0 to about 10 mole percent, of other dicarboxylic acids such as, for example, at least one diacid chosen from malonic acid, succinic acid, glutaric acid, 1,3-cyclohexanedicarboxylic, 1,4-cyclohexane-dicarboxylic acid, adipic acid, suberic acid, sebacic acid, azelaic acid, dimer acid, dodecanedioic acid, sulfoisophthalic acid, 2,6-decahydronaphthalenedicarboxylic acid, isophthalic acid, 4,4′-biphenyldicarboxylic, 3,3′- and 4,4-stilbenedicarboxylic acid, 4,4′-dibenzyldicarboxylic acid, and 1,4-, 1,5-, 2,3-, 2,6, and 2,7-naphthalenedicarboxylic acid.

The diol residues may comprise about 75 to about 87 mole percent ethylene glycol residues, about 8 to about 15 mole percent 1,4-cyclohexanedimethanol residues, and about 5 to about 10 mole percent diethylene glycol residues. Other representative amount of 1,4-cyclohexanedimethanol concentrations include about 8 to about 14 mole percent, about 8 to about 13 mole percent, about 8 to about 12 mole percent, about 8 to about 11 mole percent, about 8 to about 10 mole percent, about 9 to about 15 mole percent, about 9 to about 14 mole percent, about 9 to about 13 mole percent, about 9 to about 12 mole percent, about 9 to about 11 mole percent, about 9 to about 10 mole percent, about 10 to about 15 mole percent, about 10 to about 14 mole percent, about 10 to about 13 mole percent, about 10 to about 12 mole percent, and about 10 to about 11 mole percent. Representative mole percentages of diethylene glycol residues in the reactor grade polyester include about 5 to about 9 mole percent, about 5 to about 8 mole percent, about 5 to about 7 mole percent, and about 5 to about 6 mole percent.

The reactor grade polyester may contain from about 0.01 to about 10 weight percent, or about 0.1 to about 1.0 weight percent, based on the total weight of the polyester, of a branching agent as noted previously for the other polyesters described herein. Conventional branching agents include polyfunctional acids, anhydrides, alcohols and mixtures thereof. The branching agent may be a polyol having 3 to 6 hydroxyl groups, a polycarboxylic acid having 3 or 4 carboxyl groups or a hydroxy acid having a total of 3 to 6 hydroxyl and carboxyl groups. Examples of such compounds include trimellitic acid or anhydride, trimesic acid, pyromellitc an hydride, trimethylolethane, trimethylolpropane, a trimer acid, and the like. The inherent viscosity of the reactor grade polyester is about 0.4 to about 1.5 dL/g or about 0.6 to about 0.9 dL/g as measured at 25° C. using 0.50 grams of polymer per 100 ml of a solvent consisting of 60% by weight phenol and 40% by weight tetrachloroethane. The reactor grade polyester can be prepared by conventional polyesterification and polycondensation methods described previously. Additives such as, for example, antioxidants, melt strength enhancers, branching agents (e.g., glycerol, trimellitic acid and anhydride), chain extenders, flame retardants, fillers, acid scavengers, dyes, colorants, pigments, antiblocking agents, flow enhancers, impact modifiers, antistatic agents, processing aids, mold release additives, plasticizers, slips, stabilizers, waxes, UV absorbers, optical brighteners, lubricants, pinning additives, foaming agents, antistats, nucleators, glass beads, metal spheres, ceramic beads, carbon black, crosslinked polystyrene beads, and the like, may be incorporated in the reactor grade polyester and the roll-fed label prepared therefrom.

The reactor grade polyester can be formed into films using procedures and methods identical to those described hereinabove for the polyester blends of the invention such as, for example, extrusion, calendering, casting, drafting, tentering, or blowing, and these films may be uniaxially or biaxially stretched as described previously. Typical stretch ratios are about 4× to about 6×. The stretching can be performed, for example, using a double-bubble blown film tower, a tenter frame, or a machine direction drafter.

For example, the heat-shrinkable film may be stretched in the machine direction (MD) at a draw ratio of about 2 to about 7; about 2 to about 6; about 3 to about 7; about 3 to about 6; about 4 to about 7; or about 4 to about 6. Typically, in stretching the film, it may be initially heated to a temperature above its glass transition temperature. For example, the film may be heated in the range of a glass transition temperature (T_{g}) of the polyester blend composition of from Tg to Tg+80° C.; Tg to Tg+60° C.; Tg to Tg+40° C.; Tg to Tg+5° C.; or Tg+10° C. to Tg+20° C. The film then may be stretched at of rate of about 10 to 300 meters per minute. Alternatively, the heat-shrinkable film may be stretched, either simultaneously or sequentially, in the transverse direction at a draw ratio of less than about 1.1, about 1.2, about 1.5, or about 2.0. For example, the heat-shrinkable may be stretched in the machine direction at a draw ratio of about 2 to about 6 and in the transverse direction at a draw ratio 0 to about 2.

After stretching, films prepared from the reactor grade polyester can exhibit an increase in crystallinity, as described previously for films produced from the polyester blends of the invention. In one embodiment of our invention, the heat shrinkable films of the invention are stretched in the machine direction to give a percent crystallinity of about 10 to about 30%. Other embodiments of the invention include stretching the film in the machine direction to give a percent crystallinity of about 11 to about 30%, about 12 to about 30%, about 13 to about 30%, about 14 to about 30%, about 15 to about 30%, about 16 to about 30%, about 17 to about 30%, about 18 to about 30%, about 19 to about 30%, about 20 to about 30%, about 22 to about 30%, and about 25 to about 30%.

As described above, post-stretch annealing or heatsetting may be used to adjust shrink properties of the film, although annealing the film under tension can cause an increase in TD growth due to additional neck-in. Generally, to avoid additional neck-in and TD growth, annealing should be carried out while the film is under low tension. For example, in one embodiment, annealing is carried out under conditions that maintain post-stretch, total neck-in of the film web to 0.5% or less.

The roll-fed labels may be prepared from the heat-shrinkable film of the present invention according to methods well known in the art and described above. The roll-fed labels can have about 25 to about 85 percent machine direction shrinkage and about 0 to about 10 percent transverse direction shrinkage or growth when immersed in water at 95° C. for 10 seconds. Some additional examples of MD shrinkage that may characterize the roll-fed labels include about 25 to about 80%; about 25 to about 75%; about 25 to about 70%; about 25 to about 65%; about 25 to about 60%; about 25 to about 50%; about 25 to about 45%; about 25 to about 40%; about 30 to about 85%; about 30 to about 80%; about 30 to about 75%; about 30 to about 70%; about 30 to about 65%; about 30 to about 60%; about 30 to about 55%; about 30 to about 50%; about 35 to about 85%; about 35 to about 80%; about 35 to about 75%; about 35 to about 70%; about 35 to about 65%; about 35 to about 60%; about 35 to about 55%; about 35 to about 50%; about 40 to about 85%; about 40 to about 80%; about 40 to about 75%; about 40 to about 70%; about 40 to about 65%; about 40 to about 60%; about 40 to about 55%; about 40 to about 50%; about 45 to about 85%; about 45 to about 80%; about 45 to about 75%; about 45 to about 70%; about 45 to about 65%; about 45 to about 60%; about 45 to about 55%; about 50 to about 85%; about 50 to about 80%; about 50 to about 75%; about 50 to about 70%; about or 50 to about 60%. In addition, the roll-fed labels may have 0 to about 4, 0 to about 5, 0 to about 6, 0 to about 7, 0 to about 8, or 0 to about 10 percent transverse direction shrinkage or growth.

The roll-fed label, according to the invention, may further comprise a voiding agent a comprising at least one polymer incompatible with the reaction-grade polyester and dispersed therein as described previously. For example, the roll-fed label can comprise a voiding agent comprising a first polymer comprising cellulose acetate, cellulose acetate propionate, or a mixture thereof; and a second polymer comprising polystyrene, polypropylene, ethylene methyl methacrylate copolymer, or a mixture thereof.

The heat shrinkable films of the present invention can have a shrink stress up to about 500 psi (3.45 MPa), about 700 psi (4.83 MPa), about 1000 psi (6.89 MPa), about 1500 psi (10.34 MPa), or up to and including 2000 psi (13.79 MPa). Lower shrink forces are usually preferable so as not to overcome the adhesive force of the label seam and/or crush the underlying container. Shrink force can be measured on a 1 inch wide strip of film, mounted in a tensile rig with a force transducer. Gauge length between grips can be 2 inches. Generally, the sample is rapidly heated with a hot air gun and the maximum force measured within about 10 seconds of heating and registered on the force transducer. Although shrink force can be reported directly in units of pounds or Newtons, shrink stress is more common and is obtained by dividing the force by the initial cross-sectional area.

This shrink force is proportional to the stretch ratio for a given formulation. There are several ways to reduce the shrink force, if required. For example, shrink force can be reduced by reducing the stretch ratio for a given formulation, annealing the film, stretching the film at a higher temperature, or a combination of these methods. The shrink force also is affect by the film structure. For example, a coextruded film having a polystyrene layer and polyester layer would have a shrink force between the shrink force of a polystyrene film and a polyester film.

The invention also includes the following embodiments that are set forth below and in paragraphs [0079]-[0097]: a polyester blend comprising:

A. a first polyester comprising:
i. diacid residues comprising about 90 to 100 mole percent, based on the total first polyester diacid residues, of the residues of terephthalic acid; and
ii. diol residues comprising about 90 to 100 mole percent, based on the total first polyester diol residues, of the residues of ethylene glycol;

and

B. a second polyester comprising:
i. diacid residues comprising about 90 to 100 mole percent, based on the total second polyester diacid residues, of the residues of terephthalic acid; and
ii. diol residues comprising about 5 to about 89 mole percent, based on the total second polyester diol residues, of the residues of ethylene glycol, about 10 to about 70 mole percent of the residues of 1,4-cyclohexanedimethanol residues, and about 1 to about 25 mole percent of the residues of diethylene glycol;
wherein the polyester blend comprises about 8 to about 15 mole percent, based on the total diol residues in the polyester blend, of the residues of 1,4-cyclohexanedimethanol.

A polyester blend that includes the embodiments of paragraph [0078], wherein the first polyester (A) comprises about 95 to 100 mole percent of the residues of terephthalic acid.

A polyester blend that includes the embodiments of paragraph [0079], wherein the first polyester (A) comprises about 2 to about 5 mole percent of the residues of 1,4-cyclohexanedimethanol, and about 2 to about 5 mole percent of the residues of diethylene glycol.

A polyester blend that includes the embodiments of paragraph [0078], wherein the first polyester (A) comprises from about 10 to about 100 weight percent recycled polyester, based on the total weight of the first polyester.

A polyester blend that includes the embodiments of paragraph [0078], wherein the second polyester (B) comprises about 95 to 100 mole percent terephthalic acid residues, about 35 to about 89 mole percent ethylene glycol residues, and about 10 to about 40 mole percent 1,4-cyclohexanedimethanol residues.

A polyester blend that includes the embodiments of paragraph [0082], wherein the second polyester (B) comprises about 50 to about 77 mole percent ethylene glycol residues, about 15 to about 35 mole percent 1,4-cyclohexanedimethanol residues, and about 8 to about 15 mole percent diethylene glycol residues.

A polyester blend that includes the embodiments of paragraph [0083], which comprises about 40 to about 60 weight percent of the first polyester (A) and about 60 to about 40 weight percent of the second polyester (B).

A polyester blend that includes the embodiments of paragraph [0084], which comprises about 50 weight percent of the first polyester (A) and about 50 weight percent of the second polyester (B).

A heat shrinkable, polyester film comprising the polyester blend of any one of paragraphs [0078]-[0085] above, wherein the film has about 25 to about 85 percent machine direction shrinkage and about 0 to about 10 percent transverse direction shrinkage or growth when immersed in water at 95° C. for 10 seconds.

A heat-shrinkable film that includes the embodiments of paragraph [0086], which is stretched at a draw ratio of about 2 to about 6 in the machine direction and at a draw ratio of 0 to about 2 in the transverse direction.

A heat-shrinkable film that includes the embodiments of paragraph [0086], which has about 35 to about 60 percent machine direction shrinkage and 0 to about 7 percent transverse direction shrinkage or growth.

A heat-shrinkable film that includes the embodiments of paragraph [0086], which is produced by extrusion, calendering, casting, drafting, tentering, or blowing.

A heat-shrinkable film that includes the embodiments of any one of paragraphs [0086]-[0089] which further comprises a voiding agent, comprising at least one polymer incompatible with the polyester blend and dispersed therein; wherein the film has about 25 to about 85 percent machine direction shrinkage and about 0 to about 10 percent transverse direction shrinkage or growth when immersed in water at 95° C. for 10 seconds.

A heat-shrinkable film that includes the embodiments of paragraph [0090], wherein the voiding agent comprises at least one polymer chosen from cellulosic polymers, starch, esterified starch, polyketones, polyesters, polyamides, polysulfones, polyimides, polycarbonates, olefinic polymers, and copolymers thereof.

A heat-shrinkable film that includes the embodiments of paragraph [0091], wherein the voiding agent comprises a first polymer comprising cellulose acetate, cellulose triacetate, cellulose acetate proprionate, cellulose acetate butyrate, hydroxypropyl cellulose, methyl ethyl cellulose, carboxymethyl cellulose, or mixtures thereof; and a second polymer comprising polyethylene, polystyrene, polypropylene, ethylene vinyl acetate, ethylene vinyl alcohol copolymer, ethylene methyl acrylate copolymer, ethylene butyl acrylate copolymer, ethylene acrylic acid copolymer, ionomer, or mixtures thereof.

A sleeve or roll-fed label comprising the heat-shrinkable film of any one of paragraphs [0086]-[0092].

A sleeve or label that includes the embodiments of paragraph [0093], which is seamed by solvent bonding, hot-melt glue, UV-curable adhesive, radio frequency sealing, heat sealing, or ultrasonic bonding.

A heat shrinkable, roll-fed label, comprising from about 60 to about 100 weight percent, based on the total weight of the label, of a reaction-grade polyester, the reaction-grade polyester comprising:
i. diacid residues comprising about 90 to 100 mole percent, based on the total diacid residues, of the residues of terephthalic acid; and
ii. diol residues comprising about 75 to about 87 mole percent ethylene glycol residues, about 8 to about 15 mole percent 1,4-cyclohexanedimethanol residues, and about 5 to about 10 mole percent diethylene glycol residues;
wherein the roll-on label is stretched in the machine direction at a draw ratio from about 2 to about 6 and has about 25 to about 85 percent machine direction shrinkage and 0 to about 10 percent transverse direction shrinkage or growth when immersed in water at 95° C. for 10 seconds.

The roll-on label that includes the embodiments of paragraph [0095] wherein the voiding agent comprises a first polymer comprising cellulose acetate, cellulose acetate propionate, or a mixture thereof; and a second polymer comprising polystyrene, polypropylene, ethylene methyl methacrylate copolymer, or a mixture thereof.

The invention is further illustrated in by the following examples.

### EXAMPLES

Film shrinkage was measured by immersing a sample of known initial length into a water bath at a temperature of 65° C. to 95° C. for 10 or 30 seconds and then measuring the change in length in each direction. Shrinkage is reported as change in length divided by original length times 100%. Nominal sample size was 100 mm by 100 mm. Samples were cut from three locations: the operator side, center, and drive side of the web.

Material distribution was characterized by measuring the film thickness at various places across its width. Neck-in was measured by comparing the width of the web before stretching with the width of the web after stretching.

The inherent viscosity, abbreviated herein as “I.V.”, refers to inherent viscosity determinations made at 25° C. using 0.25 gram of polymer per 50 mL of a solvent composed of 60 weight percent phenol and 40 weight percent tetrachloroethane. Other examples of I.V. values which may be exhibited by the polyester compositions are about 0.55 to about 0.70 dL/g, about 0.55 to about 0.65 dL/g, and about 0.60 to about 0.65 dL/g.

The glass transition temperatures (“Tg”) of polyesters and blends were determined using differential scanning calorimetry (“DSC”), according to standard methods used in the art. Tg measurements typically were determined at a scan rate of 20° C./min. An example of a DSC instrument is TA Instruments 2920 Differential Scanning Calorimeter. The shrink stress in MPa was measured at 400° F. by a shrink force tester manufactured by Oakland Instrument at Minneapolis, Minn.

The percent crystallinity of the stretched film samples report herein was measured using a TA Q2000 differential scanning calorimeter with a refrigerated cooling system. The instrument was calibrated according to its user manual. The sample size is typically about 8.0 mg and is scanned at a rate of 20° C./min. in the presence of nitrogen with a flow rate of 25 c.c./min. according to the manufacturer's recommendation. The sample first is cooled to −5° C. using a refrigerated cooling system and is then heated from −5 to 290° C. at a rate of 20° C./min with data collection and analyzed using the TA software, Universal V4.3A. The % crystallinity is defined as the sum of heat of fusion divided by 29 cal/g×100.

Comparative Examples C1, C2, C3, C4, and Examples 1-2—Comparative Comparative example films C1, C2, C3, and C4 were prepared from reaction-grade copolyesters having about 100 mole percent terephthalic acid and the diol mole percentages shown in Table 1. Comparative example C1 had a cap/core/cap multilayer structure. The core and cap layers were identical in polymer blend composition except that the core layer contained 30 weight % of a voiding agent, EMBRACE™ HIGH YIELD 1000 compound, available from Eastman Chemical Company, Kingsport Tenn. The relative thickness of cap/core/cap in the finished structures was 10/80/10. Comparative example C2 was a monolayer film without voiding agent. Example films 1 and 2 were prepared from a 50/50 blend of 2 polyesters, labeled herein as polyester (A) and polyester (B) for clarity, and their composition is also given in Table 1. Polyester (A) was a copolyester containing 100 mole percent terephthalic acid, 3.6 mole percent 1,4-cyclohexanedimethanol, 2.6 mole percent diethylene glycol, and 93.8 mole percent ethylene glycol. Polyester (B) was the same copolyester as used for Comparative Example C2.

All samples were dried before being fed to an extruder and formed into a film. For Examples 1 and 2, polyester (A) and polyester (B) were dried separately and mixed together with a 50 wt %/50 wt % ratio using a blender before being fed to the hopper of an extruder. One weight percent of PETG C00235 anti-block concentrate, available from Eastman Chemical Company, was added to each example as a processing aid to prevent film blocking. The copolyester or blend was then melted by barrel heating and screw shearing, the melt was pumped through a die, and the extrudate cast onto a chill roll into webs of various thicknesses. The webs were wound into rolls and slit to various widths if necessary. The rolls of film were stored until ready for stretching. Note that Examples 1 and 2 represent tests conducted on a single roll of film. The nominal film composition, thickness, and width are given in Table 1.

TABLE 1
Nominal Unstretched Film Composition, Thickness, and Width

| | | | | Film | |
|---|---|---|---|---|---|
| | CHDM | EG | DEG | thickness | Film width |
| Example | (Mole %) | (Mole %) | (Mole %) | (micron) | (in) |
| C1 | 22.8 | 64.7 | 12.5 | 230 | 18 |
| C2 | 22.8 | 64.7 | 12.5 | 242 | 18 |
| C3 | 49.8 | 49.4 | 0.8 | 108 | 20 |
| C4 | 61.9 | 37.3 | 0.8 | 107 | 20 |
| 1 and 2 | 13.0 | 79.4 | 7.6 | 248 | 18 |

All films were stretched in the machine direction (MD) on a pilot line consisting of six preheating rolls, four pairs of stretching rolls and two annealing rolls. The preheating and annealing rolls had a diameter of 350 mm and the stretching rolls had a diameter of 100 mm. All rolls had a width or 670 mm. Roll speed and temperature could be varied on individual rolls. The six preheat rolls were set at 65° C., 70° C., 75° C., 80° C., 75° C., and 75° C., respectively, unless otherwise noted. The annealing roll temperatures were set at 30° C. unless otherwise noted.

Each film was stretched in the MD with different draw ratios. The four pairs of draw rolls had increasing speed such that an equal friction ratio was maintained between each pair of draw rolls (three stretching stations). For example, for a total draw ratio of 5.5, the film is stretched 1.77 times between the first and second pair of draw rolls, and 1.77 times again between the second and third pair of draw rolls, and 1.77 times again between the third and fourth pair of draw rolls for a total draw ratio of 1.77×1.77×1.77=5.5. The total draw ratios were determined so that the stretched film would have the desired thickness and shrinkage. Three 100 mm×100 mm samples of each film were taken from the operator side, center, and drive side, respectively, and immersed in 85° C. for 30 seconds and 95° C. for 30 seconds. These tests were done quickly to give some immediate feedback while stretching the various rolls of film and to determine the effects of various processing conditions. The results of these measurements are shown in Table 2. The data in Table 2, however, represent the shrink characteristics of film produced under variable, non-steady state processing conditions and are not believed to reflect the true performance of films prepared under typical steady state processing conditions. The data in Table 2, however, is presented for completeness. A negative number for shrinkage percentage denotes film growth and a positive number denotes film shrinkage.

TABLE 2
30 second shrinkage percent at 80° C. and 95° C.

| | | Operator Side | | Center | | Drive Side | |
|---|---|---|---|---|---|---|---|
| | Draw | Shrinkage, % | | Shrinkage, % | | Shrinkage, % | |
| Example | Ratio | MD | TD | MD | TD | MD | TD |

Temperature of 80° C.

| | | | | | | | |
|---|---|---|---|---|---|---|---|
| C1 | 5.5 × 1 | 76 | −6 | 76 | −1 | 77 | −6 |
| C2 | 5.5 × 1 | 81 | −9 | 81 | −5 | 80 | −8 |
| C3 | 3.0 × 1 | 60 | −7 | 61 | 2 | 64 | −9 |
| C4 | 2.0 × 1 | 48 | −3 | 49 | 0 | 48 | −3 |
| 1 | 5.5 × 1 | 33 | 8 | 35 | 6 | 33 | 6 |
| 2 | 5.5 × 1 | 36 | 6 | 36 | 6 | 38 | 6 |

Temperature of 95° C.

| | | | | | | | |
|---|---|---|---|---|---|---|---|
| C1 | 5.5 × 1 | 79 | −5 | 79 | 0 | 79 | −4 |
| C2 | 5.5 × 1 | 81 | −8 | 82 | −5 | 82 | −6 |
| C3 | 3.0 × 1 | 64 | −6 | 64 | −2 | 61 | −10 |
| C4 | 2.0 × 1 | 50 | 1 | 49 | 0 | 51 | −4 |
| 1 | 5.5 × 1 | 49 | 5 | 50 | 6 | 50 | 5 |
| 2 | 5.5 × 1 | 50 | 6 | 60 | 6 | 49 | 5 |

Samples also were taken during steady-state processing conditions and their 10-second shrinkage data are presented in Table 3. The shrinkage data were measured by submerging 100 mm×100 mm film samples into water for 10 seconds at temperatures from 65° C. to 95° C. The temperature was varied in increments of 5° C. Samples were taken from the operator side, center, and drive side of the webs. The shrinkage data are shown in Table 3 and are believed to represent more closely the true performance of the film samples.

TABLE 3
10 second shrinkage data

| | Operator Side | | Center | | Drive Side | |
|---|---|---|---|---|---|---|
| Temperature | Shrinkage, % | | Shrinkage, % | | Shrinkage, % | |
| ° C. | MD | TD | MD | TD | MD | TD |

Comparative Example C1

| | | | | | | |
|---|---|---|---|---|---|---|
| 65 | 25 | −2 | 29 | −5 | 29 | −3 |
| 70 | 53 | −4 | 55 | −3 | 54 | −5 |
| 75 | 68 | −10 | 70 | −5 | 68 | −8 |
| 80 | 74 | −10 | 75 | −6 | 75 | −9 |
| 85 | 77 | −10 | 78 | −6 | 77 | −10 |
| 90 | 78 | −9 | 79 | −6 | 78 | −9 |
| 95 | 79 | −10 | 79 | −6 | 78 | −10 |

Comparative Example C2

| | | | | | | |
|---|---|---|---|---|---|---|
| 65 | 26 | −1 | 28 | −5 | 28 | −2 |
| 70 | 58 | −12 | 60 | −8 | 58 | −9 |
| 75 | 75 | −18 | 76 | −10 | 75 | −22 |
| 80 | 75 | −19 | 80 | −9 | 79 | −19 |
| 85 | 80 | −20 | 80 | −8 | 81 | −25 |
| 90 | 81 | −19 | 82 | −7 | 81 | −25 |
| 95 | 83 | −17 | 82 | −7 | 82 | −21 |

Comparative Example C3

| | | | | | | |
|---|---|---|---|---|---|---|
| 65 | 2 | −1 | 3 | 0 | 2 | −1 |
| 70 | 5 | 0 | 6 | 2 | 5 | 1 |
| 75 | 12 | 1 | 16 | 2 | 18 | 2 |
| 80 | 40 | −7 | 48 | 2 | 43 | −7 |
| 85 | 63 | −14 | 64 | −5 | 62 | −23 |
| 90 | 66 | −25 | 65 | −7 | 66 | −23 |
| 95 | 66 | −23 | 65 | −8 | 65 | −22 |

Comparative Example C4

| | | | | | | |
|---|---|---|---|---|---|---|
| 65 | 0 | 0 | 0 | 0 | 0 | 0 |
| 70 | 2 | 0 | 3 | 0 | 2 | 0 |
| 75 | 8 | 0 | 10 | 2 | 8 | 1 |
| 80 | 26 | 1 | 29 | 2 | 26 | −1 |
| 85 | 48 | −12 | 48 | −2 | 48 | −10 |
| 90 | 50 | −10 | 50 | −2 | 50 | −7 |
| 95 | 51 | −14 | 50 | −2 | 50 | −7 |

Example 1

| | | | | | | |
|---|---|---|---|---|---|---|
| 65 | 0 | 0 | 2 | 1 | 1 | 1 |
| 70 | 5 | 4 | 7 | 6 | 5 | 4 |
| 75 | 13 | 2 | 16 | 4 | 15 | 2 |
| 80 | 25 | 2 | 27 | 2 | 26 | 2 |
| 85 | 36 | 5 | 38 | 5 | 35 | 3 |
| 90 | 41 | 3 | 45 | 4 | 46 | 1 |
| 95 | 47 | 2 | 49 | 4 | 47 | 0 |

Example 2

| | | | | | | |
|---|---|---|---|---|---|---|
| 65 | 1 | 1 | 1 | 1 | 1 | 1 |
| 70 | 6 | 5 | 6 | 3 | 6 | 5 |
| 75 | 16 | 2 | 16 | 2 | 18 | 3 |
| 80 | 27 | 6 | 27 | 1 | 26 | 6 |
| 85 | 42 | 5 | 40 | 4 | 42 | 3 |
| 90 | 49 | 3 | 49 | 4 | 47 | 3 |
| 95 | 51 | 3 | 52 | 4 | 50 | 2 |

The MD shrinkage for Comparative Example C2 reaches 80% at 80° C. The MD shrinkage data sets at the three locations substantially overlap at all measured temperatures. Significant position dependency is not seen for MD shrinkage. The three TD shrinkage data sets, however, do not substantially overlap. The two outer edges (operator side and drive side) show greater TD growth than the center sample. Comparative Example C2 shows high TD growth (greater than 5%) and variation across the width of the web.

The MD shrinkage for Comparative Example C3 was as high as 64% at 85° C. The MD shrinkage data at the three locations substantially overlap at all measured temperatures. Significant position dependency is not seen for MD shrinkage. The three TD shrink curves, however, do not substantially overlap at temperatures above 75° C. The two outer edges (operator side and drive side) show greater TD growth than the center sample. Comparative Example C3 shows high TD growth (greater than 5%) and variation across the width of the web.

The MD shrinkage for Comparative Example C4 was 48% at 85° C. The MD shrinkage data sets at the three locations substantially overlap. Significant position dependency across the width of the film is not seen for MD shrinkage. The three TD shrink curves, however, do not substantially overlap at temperatures above 80° C. The two outer edge samples (operator side and drive side) show greater TD growth than the center sample. Comparative Example C4 shows high TD growth (greater than 5%) and variation across the film.

The MD shrinkage for Example 1 and Example 2 are between 41 and 49% at 90° C. The MD shrinkage data sets at the three locations substantially overlap for Example 1 and Example 2, respectively. Significant position dependency is not seen for MD shrinkage. Furthermore, TD shrinkage stays below 6% at 90° C. and is less variable across the film than for Comparative Examples C₁-C₄.

The thickness of each stretched film for Comparative Examples C1 through C4 and Example 2 was measured across the width of the web at ½ inch increments. The film thickness measurements were not taken for Example 1. The first inch on each outside web edge was ignored as the webs had not been physically trimmed. Mean thickness and thickness standard deviation are given in Table 4, and the detailed data measurements are given in Table 5. Example 2 showed the most uniform thickness. A lower mean thickness standard deviation is an indication of better material distribution across the roll of film. The U-shaped profile, as seen with Comparative Examples C3 and C4 which had higher thickness measurements near each edge than in the middle of the web, indicate significantly more material is at the edges of the film than in the center due to greater neck-in.

The overall web roll width of Comparative Examples C1 through C4 and Examples 1 and 2 were measured before and after stretching. Total neck-in % is the percentage of width reduction caused by stretching. As the amount of neck-in typically increases with increased stretching, a useful measure is the normalized neck-in which is the total neck-in divided by the draw ratio. Total Neck-in and normalized neck-in are given in Table 4. Examples 1 and 2 had lower normalized neck-in than Comparative Examples C1 through C4 and lower total neck-in than Comparative Examples C1 through C3.

TABLE 4
Overall Film Characteristics Impacted by MDO Stretching

| | | Mean | Mean | Width | Width | | |
|---|---|---|---|---|---|---|---|
| | Draw | Thickness | Thickness | before | after | Total | Normalized |
| Example | Ratio | (microns) | std. dev. | stretch | stretch | Neck-in % | Neck-in |
| C1 | 5.5 × 1 | 42 | — | 18 | — | — | — |
| C2 | 5.5 × 1 | 48 | 4.6 | 18 | 15 | 17 | 3.1 |
| C3 | 3.0 × 1 | 39 | 5.5 | 20 | 16⅜ | 18 | 6 |
| C4 | 2.0 × 1 | 56 | 5.5 | 20 | 18½ | 7.5 | 3.8 |
| 1 | 5.5 × 1 | — | — | 18 | 16¼ | 10 | 1.8 |
| 2 | 5.5 × 1 | 49 | 3.1 | 18 | 16½ | 8 | 1.5 |

TABLE 5
Thickness Measurements of Stretched Films -
every 0.5 inches across the film

| | Comparative | Comparative | Comparative | |
|---|---|---|---|---|
| Measurement | Example C1 | Example C3 | Example C4 | Example 2 |
| 1 | 64 | 48 | 46 | 53 |
| 2 | 60 | 49 | 43 | 49 |
| 3 | 60 | 46 | 38 | 53 |
| 4 | 58 | 44 | 39 | 52 |
| 5 | 54 | 53 | 39 | 50 |
| 6 | 56 | 47 | 35 | 45 |
| 7 | 56 | 44 | 37 | 44 |
| 8 | 55 | 46 | 34 | 46 |
| 9 | 56 | 44 | 35 | 47 |
| 10 | 54 | 48 | 35 | 47 |
| 11 | 52 | 51 | 37 | 45 |
| 12 | 55 | 48 | 36 | 48 |
| 13 | 55 | 49 | 37 | 49 |
| 14 | 53 | 47 | 37 | 52 |
| 15 | 51 | 48 | 38 | 51 |
| 16 | 52 | 46 | 39 | 50 |
| 17 | 51 | 45 | 35 | 48 |
| 18 | 51 | 45 | 33 | 48 |
| 19 | 49 | 45 | 35 | 50 |
| 20 | 56 | 46 | 32 | 51 |
| 21 | 53 | 44 | 36 | 46 |
| 22 | 51 | 46 | 34 | 45 |
| 23 | 51 | 50 | 36 | 45 |
| 24 | 53 | 51 | 36 | 51 |
| 25 | 54 | — | 37 | 51 |
| 26 | 55 | — | 37 | — |
| 27 | 55 | — | 43 | — |
| 28 | 57 | — | 41 | — |
| 29 | 59 | — | — | — |
| 30 | 58 | — | — | — |
| 31 | 62 | — | — | — |

Examples 3-10, and Comparative Examples C₅-C₆. Effect of sequential stretching at constant draw ratio—Examples 3-10 were prepared from blends of polyesters (A) and (B) in the ratios set forth in Table 7. Comparative Example C5 was prepared from 100% polyester (A) while Comparative Example C6 was prepared from 100% polyester (B). The overall composition of the films are shown in Table 6. The manner in which the film was stretched, however, was varied among the examples. Some films were stretched by increasing the relative speed of only one pair of draw rolls (1 stretch), some films were stretched by increasing the relative speed of two pairs of draw rolls (2 stretches), and some films were stretched by increasing the relative speed of three pairs of draw rolls (3 stretches).

Polyester (A) and polyester (B) for Examples 3-10 and Comparative Examples C₅-C₆ had the same composition as in the previous set of experiments. That is, polyester (A) contained 100 mole percent terephthalic acid, 3.6 mole percent 1,4-CHDM, 2.6 mole percent DEG, and 93.8 mole percent EG. Polyester (B) was the same copolyester as used for Comparative Example C2.

Examples 3-10 and Comparative Examples C₅-C₆ were made into multilayer films with a cap/core/cap structure. The core and cap layers were identical in polymer blend composition except that the cap layers had the antiblock additive. The nominal relative thickness of cap/core/cap in the finished structures was 10/80/10.

Pellets of polyester (A) and polyester (B) were pre-dried separately prior to extrusion. Multilayer films were made using mixtures of given ratios of polyester (A) and polyester (B) added to an extruder and a coextruder. Comparative Examples C5 and C6 used 100% polyester (A) and 100% polyester (B), respectively. In all Examples, 1 weight percent of PETG C00235 anti-block concentrate, based upon the total weight of polyester added to the coextruder, was added to the coextruder which fed both cap layers. Both extruders were twin screw extruders with venting.

The films of Examples 3-10 and Comparative Examples C5-C6 were prepared in a continuous manner, including mixing the polyesters (for Examples 3-10), feeding the pellets, extruding, casting the film, and stretching the film in the machine direction. The extruded polymer was cast into films. The cast films were scanned with a beta-ray thickness gauge for manual thickness adjustment. The cast films were stretched as described below.

Example 3 was made by feeding polyester (A) and polyester (B) in equal quantities into the extruder and coextruder. The material was melt blended and extruded, and cast into a film as described above. As the film was produced, it was fed directly to the stretching machine consisting of six preheat rolls, four pairs of draw rolls, and two annealing rolls. The preheat roll temperature set points were 65° C., 70° C., 75° C., 80° C., 75° C., and 75° C., respectively. The draw roll temperatures were set at 78° C., 88° C., 70° C., and 68° C., respectively. The annealing roll temperatures were each set at 30° C.

Examples 4-10 were made by the same procedure as Example 3 with the composition and draw ratio changes shown in Table 6 and Table 7, respectively. Variations from the procedure in Example 3 were as follows: Example 5, the first draw roll temperature set point was 75° C.; Example 6, the first draw roll temperature set point was 88° C.; Example 6 was repeated with the first draw roll temperature set point was 94° C.; Example 8, the third draw roll temperature set point was 88° C.; Example 9, the first and third draw roll temperature set points were 92° C. and 88° C., respectively; Example 10, the second and the third draw roll temperature set points were each 90° C.

Comparative Examples C5 and C6 were prepared by feeding 100% polyester (A) and 100% polyester (B), respectively into the extruder and coextruder. The other differences from Example 3 were as follows: Example C5, the second and the third draw roll temperature set points were each 90° C.; Example C6, the second and the third draw roll temperature set points were each 86° C. Comparative Examples C5 and C6 were stretched using two stretches as noted in Table 7.

TABLE 6
Unstretched film characteristics

| | | | | Unstretched |
|---|---|---|---|---|
| | CHDM | EG | DEG | Film thickness |
| Example | Mole % | Mole % | Mole % | (microns) |
| 3-6 | 13.0 | 79.4 | 7.6 | 275 |
| 7-9 | 14.7 | 76.8 | 8.5 | 250 |
| 10 | 11.0 | 82.2 | 6.8 | 250 |
| C5 | 3.6 | 93.8 | 2.6 | 250 |
| C6 | 22.8 | 64.7 | 12.5 | 250 |

TABLE 7
Composition and Stretching Protocols for Examples 3-10 and Comparative
Examples C5-C6

| | Wt % | | | | | |
|---|---|---|---|---|---|---|
| | polyester | Total | FR | | | |
| Example | (A)/(B) | DR | #1 | FR #2 | FR #3 | # of Stretches |
| 3 | 50/50 | 5.0 | 1.00 | 5.00 | 1.00 | 1 |
| 4 | 50/50 | 5.0 | 1.00 | 5.00 | 1.00 | 1 |
| 5 | 50/50 | 5.0 | 2.24 | 2.24 | 1.00 | 2 |
| 6 | 50/50 | 5.0 | 1.71 | 1.71 | 1.71 | 3 |
| 7 | 40/60 | 5.0 | 1.00 | 5.00 | 1.00 | 1 |
| 8 | 40/60 | 5.0 | 1.00 | 2.24 | 2.24 | 2 |
| 9 | 40/60 | 5.0 | 1.71 | 1.71 | 1.71 | 3 |
| 10 | 60/40 | 5.0 | 1.00 | 2.24 | 2.24 | 2 |
| C5 | 100/0 | 5.0 | 1.00 | 2.24 | 2.24 | 2 |
| C6 | 0/100 | 5.0 | 1.00 | 2.24 | 2.24 | 2 |

Shrinkage data were measured for Examples 3 and 5-10 and Comparative Examples C5-C6. No shrinkage data was collected for Example 4. All shrink curves were determined by submerging 100 mm×100 mm film samples into water for 10 seconds at temperatures from 70° C. to 95° C. Shrinkage data was also measured for Comparative Example C5 at 65° C. and for Comparative Example C6 at 60° C. and 65° C. The temperature was varied in increments of 5° C. Samples were taken from the operator side, center, and drive side of the films except for Comparative Example C6 which was not wide enough for three samples; therefore, only operator side and drive side samples were taken. The data are shown in Table 8.

TABLE 8
10 second shrinkage data

| | Operator Side | | Center | | Drive Side | |
|---|---|---|---|---|---|---|
| Temperature | Shrinkage, % | | Shrinkage, % | | Shrinkage, % | |
| (° C.) | MD | TD | MD | TD | MD | TD |

Example 3

| | | | | | | |
|---|---|---|---|---|---|---|
| 70 | 5.0 | 4.0 | 4.0 | 3.0 | 4.0 | 3.0 |
| 75 | 11.0 | 5.0 | 12.0 | 5.0 | 12.0 | 5.0 |
| 80 | 23.0 | 6.0 | 21.0 | 5.0 | 23.0 | 5.0 |
| 85 | 30.0 | 4.0 | 32.0 | 3.0 | 32.0 | 4.0 |
| 90 | 40.0 | 3.0 | 38.0 | 3.0 | 40.0 | 2.0 |
| 95 | 43.0 | 2.0 | 41.0 | 3.0 | 43.0 | 3.0 |

Example 5

| | | | | | | |
|---|---|---|---|---|---|---|
| 70 | 7.0 | 5.0 | 8.0 | 6.0 | 10.0 | 7.0 |
| 75 | 17.0 | 8.0 | 18.0 | 8.0 | 19.0 | 7.0 |
| 80 | 33.0 | 5.0 | 35.0 | 5.0 | 35.0 | 5.0 |
| 85 | 46.0 | 1.0 | 45.0 | 2.0 | 46.0 | 2.0 |
| 90 | 52.0 | −1.0 | 50.0 | 2.0 | 52.0 | 0.0 |
| 95 | 56.0 | 0.0 | 53.0 | 1.0 | 52.0 | 1.0 |

Example 6 (draw roll set point of 88° C.)

| | | | | | | |
|---|---|---|---|---|---|---|
| 70 | 10.0 | 8.0 | 10.0 | 8.0 | 12.0 | 8.0 |
| 75 | 24.0 | 8.0 | 28.0 | 9.0 | 24.0 | 10.0 |
| 80 | 45.0 | 5.0 | 47.0 | 5.0 | 47.0 | 7.0 |
| 85 | 47.0 | 2.0 | 49.0 | 3.0 | 50.0 | 3.0 |
| 90 | 58.0 | 0.0 | 60.0 | 2.0 | 55.0 | 1.0 |
| 95 | 63.0 | 2.0 | 62.0 | 4.0 | 58.0 | 2.0 |

Example 6 (draw roll set point of 94° C.)

| | | | | | | |
|---|---|---|---|---|---|---|
| 70 | 10.0 | 6.0 | 10.0 | 7.0 | 11.0 | 8.0 |
| 75 | 31.0 | 7.0 | 28.0 | 8.0 | 31.0 | 7.0 |
| 80 | 45.0 | 5.0 | 48.0 | 3.0 | 48.0 | 3.0 |
| 85 | 52.0 | 1.0 | 51.0 | 2.0 | 54.0 | 1.0 |
| 90 | 58.0 | 0.0 | 59.0 | 1.0 | 59.0 | 1.0 |
| 95 | 62.0 | 1.0 | 64.0 | 2.0 | 62.0 | 3.0 |

Example 7

| | | | | | | |
|---|---|---|---|---|---|---|
| 70 | 6.0 | 6.0 | 7.0 | 6.0 | 7.0 | 6.0 |
| 75 | 18.0 | 7.0 | 20.0 | 6.0 | 21.0 | 7.0 |
| 80 | 35.0 | 4.0 | 38.0 | 3.0 | 38.0 | 3.0 |
| 85 | 46.0 | 1.0 | 45.0 | 1.0 | 45.0 | 0.0 |
| 90 | 52.0 | 0.0 | 55.0 | 0.0 | 54.0 | 0.0 |
| 95 | 55.0 | 1.0 | 55.0 | 1.0 | 55.0 | −1.0 |

Example 8

| | | | | | | |
|---|---|---|---|---|---|---|
| 70 | 12.0 | 7.0 | 13.0 | 7.0 | 13.0 | 8.0 |
| 75 | 28.0 | 5.0 | 30.0 | 5.0 | 30.0 | 6.0 |
| 80 | 49.0 | 0.0 | 47.0 | 1.0 | 48.0 | 2.0 |
| 85 | 55.0 | −2.0 | 53.0 | −1.0 | 56.0 | −2.0 |
| 90 | 61.0 | −2.0 | 62.0 | −2.0 | 61.0 | −2.0 |
| 95 | 64.0 | −2.0 | 65.0 | −1.0 | 63.0 | −2.0 |

Example 9

| | | | | | | |
|---|---|---|---|---|---|---|
| 70 | 16.0 | 7.0 | 14.0 | 7.0 | 14.0 | 7.0 |
| 75 | 37.0 | 7.0 | 35.0 | 7.0 | 37.0 | 6.0 |
| 80 | 50.0 | 3.0 | 52.0 | 1.0 | 52.0 | 0.0 |
| 85 | 60.0 | −4.0 | 62.0 | −3.0 | 62.0 | −3.0 |
| 90 | 66.0 | −4.0 | 64.0 | −5.0 | 64.0 | −5.0 |
| 95 | 70.0 | −1.0 | 68.0 | −2.0 | 72.0 | −1.0 |

Example 10

| | | | | | | |
|---|---|---|---|---|---|---|
| 70 | 2.0 | 2.0 | 2.0 | 2.0 | 2.0 | 2.0 |
| 75 | 12.0 | 5.0 | 14.0 | 6.0 | 10.0 | 6.0 |
| 80 | 18.0 | 7.0 | 18.0 | 6.0 | 19.0 | 6.0 |
| 85 | 24.0 | 5.0 | 23.0 | 5.0 | 23.0 | 6.0 |
| 90 | 30.0 | 4.0 | 33.0 | 4.0 | 32.0 | 4.0 |
| 95 | 40.0 | 4.0 | 35.0 | 3.0 | 38.0 | 3.0 |

Comparative Example C5

| | | | | | | |
|---|---|---|---|---|---|---|
| 65 | 0.0 | 0.0 | 0.0 | 0.0 | 0.0 | 0.0 |
| 70 | 2.0 | 2.0 | 2.0 | 2.0 | 3.0 | 1.0 |
| 75 | 4.0 | 4.0 | 4.0 | 3.0 | 3.0 | 3.0 |
| 80 | 7.0 | 4.0 | 6.0 | 5.0 | 6.0 | 5.0 |
| 85 | 7.0 | 7.0 | 8.0 | 8.0 | 8.0 | 8.0 |
| 90 | 10.0 | 5.0 | 11.0 | 7.0 | 13.0 | 7.0 |
| 95 | 14.0 | 8.0 | 15.0 | 8.0 | 14.0 | 8.0 |

Comparative Example C6

| | | | | | | |
|---|---|---|---|---|---|---|
| 60 | 10 | −4 | — | — | 10 | −4 |
| 65 | 38.0 | −11.0 | — | — | 41.0 | −10.0 |
| 70 | 57.0 | −13.0 | — | — | 59.0 | −14.0 |
| 75 | 75.0 | −17.0 | — | — | 76.0 | −17.0 |
| 80 | 79.0 | −18.0 | — | — | 79.0 | −16.0 |
| 85 | 80.0 | −15.0 | — | — | 79.0 | −17.0 |
| 90 | 80.0 | −17.0 | — | — | 80.0 | −16.0 |
| 95 | 80.0 | −18.0 | — | — | 81.0 | −15.0 |

Table 8 shows the film shrinkage data for a 50/50 blend of polyester (A) and polyester (B) stretched under different conditions. For Example 3, the entire draw ratio of 5.0 was taken by increasing the speed of one pair of draw rolls (1 stretch). For Example 5, the draw ratio was accomplished in two equal fractions by progressively increasing the speed of two adjacent pairs of draw rolls (2 stretches). For Example 6, the draw ratio was accomplished in three equal fractions by progressively increasing the speed of three adjacent pairs of draw rolls (3 stretches). For each of the three examples, the MD and TD shrinkage data across the film (i.e., operator side, center, and driver side) substantially overlap. The MD shrinkage at 90° C. increased from approximately 40% when stretched with one stretch to approximately 60% when stretched with three stretches. The TD shrinkage remained below 5% and consistent across the film.

Table 8 shows the film shrinkage data for a 40/60 blend of polyester (A) and polyester (B) stretched under different conditions. For Example 7, the entire draw ratio of 5.0 was taken by increasing the speed of one pair of draw rolls (1 stretch). For Example 8, the draw ratio was accomplished in two equal fractions by progressively increasing the speed of two adjacent pairs of draw rolls (2 stretches). For Example 9, the draw ratio was accomplished in three equal fractions by progressively increasing the speed of three adjacent pairs of draw rolls (3 stretches). For each of the three examples, the MD and TD shrinkage data across the film (i.e., operator side, center, and driver side) substantially overlap. The MD shrinkage at 90° C. increased from approximately 50% when stretched with one stretch to approximately 65% when stretched with three stretches. The TD shrinkage remained below 5% and consistent across the film.

Table 8 shows the shrinkage data for a 60/40 blend of polyester (A) and polyester (B), Example 10, stretched under conditions such that the draw ratio was accomplished in two equal fractions by progressively increasing the speed of two adjacent pairs of draw rolls (2 stretches). At 90° C., the MD shrinkage was around 30% and the TD shrinkage was less than 5%.

Table 9 gives a direct comparison of the MD and TD shrinkage for films made from different ratios of polyester (A) and polyester (B) and stretched under different conditions. The MD shrinkage percentage was modified by changing either the ratio of polyester (A) to polyester (B) for a given stretching protocol or by changing the number of stretches while using the same ratio of polyester (A) to polyester (B). The TD shrinkage percentage was below 5% under each of these conditions.

TABLE 9
MD and TD Percent Shrinkage at 90° C. for 10 seconds -
Average measurements

| Blend | | | | | | |
|---|---|---|---|---|---|---|
| Composition | | | | | | |
| Wt % Polyester | 1 stretch | | 2 stretches | | 3 stretches | |
| (A)/(B) | MD (%) | TD (%) | MD (%) | TD (%) | MD (%) | TD (%) |
| Ex. 10 (60/40) | — | — | 32 | 4.0 | — | — |
| Ex. 3-6 (50/50) | 39 | 2.7 | 51 | 0.3 | 59 | 0.7 |
| Ex. 7-9 (40/60) | 54 | 0 | 61 | −2.0 | 65 | −4.7 |

Table 8 also shows the shrinkage data for Comparative Example C5, 100% polyester (A) film, and Comparative Example C6, 100% polyester (B) film, respectively. Comparative Example C5 had a MD shrinkage of 15% and below, which makes it unsuitable for most shrink film applications. Comparative Example C6 had a MD shrinkage of 80% at 90 and 95° C. The TD growth, however, was between 15 and 18%.

The neck-in of Examples 3-10 and Comparative Examples C₅-C₆ are given in Table 10. Examples 3-10 of the present invention had a normalized neck-in of 1.1% to 2.1% whereas Comparative Example C6, 100% polyester (B), had a normalized neck-in of 3.2%.

TABLE 10
Neck-In for Examples 3-10 and Comparative
Examples C5-C6 at a draw ratio of 5.

| | Width before | Width after | Neck-in | Normalized |
|---|---|---|---|---|
| Example | stretching (mm) | stretching (mm) | % | Neck-in |
| 3 | 402 | 380 | 5 | 1.1 |
| 4 | 404 | 380 | 6 | 1.2 |
| 5 | 402 | 375 | 1 | 1.3 |
| 6 | 402 | 370 | 2 | 1.6 |
| 7 | 384 | 355 | 2 | 1.5 |
| 8 | 382 | 345 | 10 | 1.9 |
| 9 | 388 | 348 | 10 | 2.1 |
| 10 | 382 | 345 | 10 | 1.9 |
| C5 | 384 | 355 | 8 | 1.5 |
| C6 | 380 | 320 | 16 | 3.2 |

Examples 11-21 and Comparative Examples C₇-C₁₃—A third set of experiments were performed using monolayer films. The compositions of Examples 11-21 and Comparative Examples C7-C13 are given in Table 11. Examples 11-13 were a 40 weight %/60 weight % blend of polyester (A) and polyester (B). Examples 14 and C11-C13 contained a 50 weight %/50 weight % blend of polyester (A) and polyester (B). Examples 15-16 and contained a 60 weight %/40 weight % blend of polyester (A) and polyester (B). Examples 17-19 and C₇-C₈ were reactor-grade PET copolyesters with compositions as given in Table 11. Examples C9 and C10 were mislabled during the experiment as having the blend composition of Examples 11-13. Based upon the composition analysis of the films tested, examples C9 and C10 are presumed to be the same reactor grade PET copolyester as example C7. Examples 20-21 contained 28 weight percent of EMBRACE™ HY voiding agent, available from Eastman Chemical Company. Example 20 is a reactor-grade PET copolyester with the copolyester composition listed in Table 11 with the voiding agent. Example 21 was a 50 weight %/50 weight % blend of polyester (A) and polyester (B) with the voiding agent. The thicknesses reported in Table 11 are after stretching.

One weight percent of PETG C00235 anti-block concentrate available from Eastman Chemical Company, Kingsport, Tenn., was added to each Example and Comparative Example as a processing aid to prevent film blocking. No anti-block was added, however, to the films containing the voiding agent.

All films were stretched in the machine direction (MD) on an MDO machine manufactured by Alpine consisting of 4 preheat rolls (identified as P1-P4), one pair of stretching rolls (identified as S5-S6) with one gap, and seven annealing and cooling rolls (identified as A7-A13). All rolls had individual drive and temperature control. P1-P4 and S5-S6, and A13 (i.e., the last annealing and cooling roll) had individual nip rolls. Roll S5 also had two distance-adjustable film edge rollers to reduce neck-in.

Example 11 was stretched at an initial line speed of 5.0 m/min and a draw ratio (“DR”) of 5.0. The friction ratio (“FR”) at P2, P3, P4, and S5 was 1.00, 1.02, 1.03, and 1.10 respectively. The friction ratios at A7-A13 were each 1.00. The annealing and cooling roll temperatures for A7-A13 were, 168° C., 140° C., 122° C., 104° C., 104° C., 104° C., and 86° C., respectively.

Example 12 was stretched by the same procedure as Example 11 except at an initial line speed of 3.0 m/min. Example 13 was stretched by the same procedure as Example 11 except at an initial line speed of 7.0 m/min.

Examples 14-21 were stretched at an initial line speed of 7.0 m/min and a draw ratio of 5.0. The friction ratio at P2, P3, P4, and S5 was 1.00, 1.02, 1.03, and 1.10 respectively. The friction ratios at A7-A13 were each 1.00. The annealing and cooling roll temperatures for A7-A13 were, 168° C., 140° C., 122° C., 104° C., 104° C., 104° C., and 86° C., respectively. For Example 16, the friction ratios of A7-A13 were 1.09, 0.96, 0.96, 0.96, 0.99, 1.00, and 1.03, respectively.

Comparative Example C7 was stretched under the same conditions as Example 11. Comparative Example C₈-C₁₁ were stretched under the same conditions as Example 14, at draw ratios given in Table 14. Comparative Examples C12-C13 were stretched under the same conditions as Example 14 except that for Comparative Example C12 the temperature of rolls A7-A11 was set at 180° C. and for Comparative Example C13 the temperature of rolls A7-A8 was set at 180° C.

TABLE 11
Film Composition and Thickness

| | | | | | Film |
|---|---|---|---|---|---|
| | Mole % | Mole % | Mole % | Weight % | thickness |
| Example | 1,4-CHDM | EG | DEG | voiding agent | (micron) |
| 11 | 12.8 | 79.6 | 7.6 | 0 | 41 |
| 12 | 12.8 | 79.6 | 7.6 | 0 | 44 |
| 13 | 13.2 | 79.0 | 7.8 | 0 | 52 |
| 14 | 13.1 | 79.1 | 7.8 | 0 | 53 |
| 15 | 11.1 | 82.1 | 6.8 | 0 | 46 |
| 16 | 10.8 | 82.8 | 6.4 | 0 | 46 |
| 17 | 12.2 | 86.4 | 1.4 | 0 | 44 |
| 18 | 12.1 | 86.4 | 1.5 | 0 | 56 |
| 19 | 12.1 | 86.4 | 1.5 | 0 | 65 |
| 20 | 12.1 | 86.4 | 1.5 | 28 | 74 |
| 21 | 13.2 | 79.0 | 7.9 | 28 | 64 |
| C7 | 22.8 | 64.8 | 12.4 | 0 | 81 |
| C8 | 19.7 | 78.3 | 2.0 | 0 | 77 |
| C9 | 22.6 | 65.0 | 12.4 | 0 | 74 |
| C10 | 20.1 | 68.6 | 11.3 | 0 | 58 |
| C11 | 12.7 | 80.0 | 7.3 | 0 | 85 |
| C12 | 12.8 | 79.6 | 7.6 | 0 | 55 |
| C13 | 12.3 | 80.4 | 7.3 | 0 | 55 |

Three 100 mm×100 mm samples of each film were taken from the operator side, center, and drive side of the web, respectively, and immersed in 80° C. for 10 seconds and 95° C. for 10 seconds. Comparative Example C9 was only tested at 95° C. on a sample from the center of the web. These tests were performed during the stretching process to determine the effects of various processing conditions. Results are shown in Table 12. A negative number for shrinkage percentage denotes film growth and a positive number denotes film shrinkage.

TABLE 12
10 second shrinkage percent at 80° C. and 95° C.

| | | Operator Side | | Center | | Drive Side | |
|---|---|---|---|---|---|---|---|
| | Draw | Shrinkage, % | | Shrinkage, % | | Shrinkage, % | |
| Example # | Ratio | MD | TD | MD | TD | MD | TD |

Temperature of 80° C.

| | | | | | | | |
|---|---|---|---|---|---|---|---|
| 11 | 5.0 | 20 | 3 | — | — | 20 | 7 |
| 12 | 5.0 | 20 | 5 | 21 | 6 | 20 | 6 |
| 13 | 5.0 | 32 | 2 | 33 | 4 | 31 | 2 |
| 14 | 5.0 | 33 | 4 | 31 | 3 | 30 | 2 |
| 15 | 5.0 | 22 | 6 | 23 | 7 | 24 | 7 |
| 16 | 5.0 | 12 | 4 | 13 | 5 | 12 | 5 |
| 17 | 5.0 | 5 | 4 | 5 | 4 | 5 | 4 |
| 18 | 4.0 | 13 | 4 | 15 | 6 | 12 | 5 |
| 19 | 3.5 | 15 | 1 | 19 | 2 | 16 | 1 |
| 20 | 4.0 | 11 | 2 | 12 | 5 | 11 | 3 |
| 21 | 5.0 | 33 | −2 | 32 | −1 | 32 | −2 |
| C7 | 4.3 | 73 | −77 | 73 | −66 | 73 | −75 |
| C8 | 3.2 | 53 | −18 | 55 | −14 | 52 | −19 |
| C9 | 5.0 | — | — | — | — | — | — |
| C10 | 4.0 | 66 | −32 | — | — | 65 | −34 |
| C11 | 3.0 | 56 | −24 | 56 | −23 | 54 | −25 |
| C12 | 4.9 | 12 | −2 | 12 | −3 | 12 | −3 |
| C13 | 4.9 | 15 | −1 | 18 | −2 | 17 | −2 |

Temperature of 95° C.

| | | | | | | | |
|---|---|---|---|---|---|---|---|
| 11 | 5.0 | 42 | 4 | — | — | 42 | 1 |
| 12 | 5.0 | 43 | 1 | 44 | 2 | 44 | 1 |
| 13 | 5.0 | 55 | −3 | 56 | 0 | 54 | −3 |
| 14 | 5.0 | 56 | −2 | 56 | −2 | 54 | −4 |
| 15 | 5.0 | 46 | 1 | 46 | 2 | 45 | 1 |
| 16 | 5.0 | 34 | 1 | 34 | 2 | 33 | 2 |
| 17 | 5.0 | 24 | 5 | 24 | 5 | 22 | 4 |
| 18 | 4.0 | 44 | −5 | 45 | 0 | 44 | −3 |
| 19 | 3.5 | 50 | −11 | 51 | −5 | 51 | −10 |
| 20 | 4.0 | 32 | −1 | 34 | 2 | 32 | −2 |
| 21 | 5.0 | 55 | −8 | 54 | −5 | 52 | −8 |
| C7 | 4.3 | 76 | −82 | 76 | −68 | 76 | −80 |
| C8 | 3.2 | 68 | −22 | 67 | −18 | 68 | −27 |
| C9 | 5.0 | — | — | 80 | −30 | — | — |
| C10 | 4.0 | 75 | −31 | — | — | 75 | −32 |
| C11 | 3.0 | 63 | −24 | 63 | −22 | 62 | −31 |
| C12 | 4.9 | 38 | −12 | 40 | −11 | 38 | −13 |
| C13 | 4.9 | 41 | −8 | 43 | −9 | 41 | −10 |

Shrinkage data were measured for Examples 11-21 and Comparative Examples C₇-C₁₃. Detailed shrinkage data was not measured for Example 14. Shrink data for Example 16 was collected twice. All shrink curves were developed by submerging 100 mm×100 mm film samples into water for 10 seconds at temperatures from 65° C. to 95° C. The temperature was varied in increments of 5° C. Samples were taken from the operator side, center, and drive side of the web except for Example 11 and Comparative Example C8 which were not wide enough for three samples. Only operator side and a drive side samples were measured. The data is shown in Table 13.

TABLE 13
10 second shrinkage data

| | Operator Side | | Center | | Drive Side | |
|---|---|---|---|---|---|---|
| | Shrinkage, % | | Shrinkage, % | | Shrinkage, % | |
| Temp (° C.) | MD | TD | MD | TD | MD | TD |

Example 11

| | | | | | | |
|---|---|---|---|---|---|---|
| 65 | 2 | 0 | — | — | 2 | 0 |
| 70 | 4 | 2 | — | — | 3 | 2 |
| 75 | 11 | 4 | — | — | 10 | 4 |
| 80 | 23 | 5 | — | — | 21 | 5 |
| 85 | 30 | 3 | — | — | 33 | 4 |
| 90 | 39 | 2 | — | — | 40 | 3 |
| 95 | 44 | 2 | — | — | 45 | 3 |

Example 12

| | | | | | | |
|---|---|---|---|---|---|---|
| 65 | 2 | 0 | 1 | 0 | 1 | 0 |
| 70 | 3 | 2 | 3 | 3 | 4 | 2 |
| 75 | 12 | 4 | 13 | 5 | 12 | 4 |
| 80 | 24 | 4 | 25 | 5 | 24 | 4 |
| 85 | 33 | 2 | 35 | 3 | 33 | 2 |
| 90 | 43 | 0 | 42 | 2 | 42 | 0 |
| 95 | 46 | 0 | 46 | 2 | 45 | 0 |

Example 13

| | | | | | | |
|---|---|---|---|---|---|---|
| 65 | 2 | 2 | 2 | 2 | 2 | 2 |
| 70 | 7 | 3 | 9 | 5 | 7 | 5 |
| 75 | 21 | 5 | 22 | 6 | 21 | 5 |
| 80 | 37 | 0 | 40 | 2 | 37 | 0 |
| 85 | 48 | −5 | 48 | −1 | 48 | −3 |
| 90 | 55 | −4 | 55 | −1 | 54 | −4 |
| 95 | 58 | −4 | 59 | −1 | 58 | −4 |

Example 15

| | | | | | | |
|---|---|---|---|---|---|---|
| 65 | 1 | 0 | 1 | 1 | 2 | 1 |
| 70 | 4 | 4 | 4 | 5 | 4 | 3 |
| 75 | 8 | 6 | 10 | 7 | 10 | 7 |
| 80 | 18 | 7 | 18 | 7 | 17 | 6 |
| 85 | 29 | 5 | 30 | 6 | 29 | 5 |
| 90 | 36 | 3 | 37 | 4 | 36 | 4 |
| 95 | 41 | 2 | 42 | 3 | 42 | 3 |

Example 16

| | | | | | | |
|---|---|---|---|---|---|---|
| 65 | 0 | 0 | 0 | 0 | 0 | 0 |
| 70 | 1 | 1 | 1 | 1 | 1 | 0 |
| 75 | 5 | 2 | 6 | 3 | 6 | 3 |
| 80 | 12 | 3 | 14 | 4 | 14 | 4 |
| 85 | 25 | 3 | 25 | 4 | 22 | 4 |
| 90 | 32 | 0 | 34 | 2 | 32 | 0 |
| 95 | 36 | 0 | 37 | 0 | 35 | 0 |

Example 16 (repeat sample)

| | | | | | | |
|---|---|---|---|---|---|---|
| 65 | 0 | 0 | 0 | 0 | 0 | 0 |
| 70 | 1 | 1 | 1 | 1 | 1 | 1 |
| 75 | 6 | 3 | 6 | 3 | 5 | 3 |
| 80 | 14 | 4 | 15 | 4 | 13 | 5 |
| 85 | 26 | 3 | 27 | 3 | 25 | 2 |
| 90 | 34 | 1 | 35 | 2 | 32 | 1 |
| 95 | 39 | 1 | 39 | 1 | 36 | 0 |

Example 17

| | | | | | | |
|---|---|---|---|---|---|---|
| 65 | 2 | 1 | 1 | 1 | 1 | 1 |
| 70 | 2 | 1 | 2 | 1 | 2 | 1 |
| 75 | 3 | 2 | 3 | 3 | 2 | 2 |
| 80 | 6 | 5 | 8 | 5 | 6 | 5 |
| 85 | 15 | 6 | 15 | 6 | 13 | 6 |
| 90 | 21 | 5 | 21 | 5 | 19 | 5 |
| 95 | 26 | 4 | 27 | 5 | 25 | 5 |

Example 18

| | | | | | | |
|---|---|---|---|---|---|---|
| 65 | 0 | 0 | 0 | 0 | 0 | 0 |
| 70 | 1 | 1 | 2 | 1 | 1 | 1 |
| 75 | 4 | 4 | 5 | 5 | 5 | 4 |
| 80 | 15 | 5 | 18 | 8 | 17 | 5 |
| 85 | 32 | 1 | 34 | 3 | 32 | 1 |
| 90 | 40 | 2 | 42 | 0 | 41 | −1 |
| 95 | 46 | −5 | 46 | 0 | 46 | −2 |

Example 19

| | | | | | | |
|---|---|---|---|---|---|---|
| 65 | 0 | 0 | 0 | 0 | 0 | 0 |
| 70 | 2 | 0 | 2 | 0 | 2 | 0 |
| 75 | 5 | 2 | 7 | 2 | 6 | 1 |
| 80 | 26 | 1 | 26 | 1 | 27 | −1 |
| 85 | 42 | −7 | 45 | −6 | 44 | −7 |
| 90 | 49 | −10 | 50 | −7 | 48 | −8 |
| 95 | 52 | −10 | 53 | −5 | 52 | −9 |

Example 20

| | | | | | | |
|---|---|---|---|---|---|---|
| 65 | 0 | 0 | 0 | 0 | 0 | 0 |
| 70 | 2 | 1 | 3 | 2 | 2 | 1 |
| 75 | 5 | 3 | 6 | 4 | 5 | 2 |
| 80 | 13 | 2 | 14 | 6 | 12 | 2 |
| 85 | 23 | 1 | 24 | 5 | 22 | −1 |
| 90 | 30 | −2 | 31 | 10 | 28 | −2 |
| 95 | 34 | −2 | 35 | 6 | 32 | −6 |

Example 21

| | | | | | | |
|---|---|---|---|---|---|---|
| 65 | 4 | 0 | 4 | 0 | 4 | 0 |
| 70 | 11 | 0 | 11 | 2 | 10 | 0 |
| 75 | 19 | −1 | 19 | 1 | 19 | −1 |
| 80 | 33 | −5 | 35 | −2 | 33 | −5 |
| 85 | 42 | −5 | 43 | −3 | 42 | −7 |
| 90 | 49 | −8 | 48 | −4 | 47 | −7 |
| 95 | 53 | −9 | 56 | −5 | 55 | −12 |

Example C7

| | | | | | | |
|---|---|---|---|---|---|---|
| 65 | 7 | −4 | 8 | −4 | 8 | −5 |
| 70 | 38 | −25 | 40 | −25 | 37 | −24 |
| 75 | 61 | −55 | 62 | −52 | 62 | −55 |
| 80 | 73 | −75 | 73 | −64 | 62 | −75 |
| 85 | 75 | −80 | 75 | −66 | 76 | −80 |
| 90 | 76 | −81 | 76 | −65 | 76 | −84 |
| 95 | 76 | −81 | 76 | −62 | 76 | −86 |

Example C8

| | | | | | | |
|---|---|---|---|---|---|---|
| 65 | 1 | 0 | — | — | 1 | 0 |
| 70 | 7 | 2 | — | — | 7 | 2 |
| 75 | 32 | −5 | — | — | 34 | −5 |
| 80 | 63 | −18 | — | — | 64 | −20 |
| 85 | 67 | −21 | — | — | 68 | −23 |
| 90 | 66 | −21 | — | — | 67 | −20 |
| 95 | 68 | −20 | — | — | 68 | −20 |

Example C9

| | | | | | | |
|---|---|---|---|---|---|---|
| 65 | 11 | −4 | 12 | −3 | 11 | −4 |
| 70 | 34 | −15 | 38 | −15 | 35 | −16 |
| 75 | 59 | −33 | 61 | −30 | 59 | −38 |
| 80 | 75 | −55 | 76 | −31 | 75 | −53 |
| 85 | 80 | −61 | 80 | −28 | 80 | −62 |
| 90 | 81 | −60 | 81 | −28 | 81 | −57 |
| 95 | 81 | −58 | 81 | −26 | 81 | −55 |

Example C10

| | | | | | | |
|---|---|---|---|---|---|---|
| 65 | 1 | 0 | 1 | 0 | 1 | 0 |
| 70 | 9 | 0 | 10 | 0 | 9 | 0 |
| 75 | 32 | −6 | 32 | −6 | 32 | −6 |
| 80 | 48 | −15 | 46 | −11 | 48 | −13 |
| 85 | 54 | −14 | 54 | −11 | 53 | −14 |
| 90 | 57 | −14 | 58 | −11 | 58 | −14 |
| 95 | 61 | −13 | 61 | −9 | 61 | −13 |

Example C11

| | | | | | | |
|---|---|---|---|---|---|---|
| 65 | 2 | 1 | 3 | 1 | 3 | 1 |
| 70 | 24 | −8 | 24 | −8 | 23 | −8 |
| 75 | 50 | −20 | 51 | −20 | 50 | −20 |
| 80 | 60 | −25 | 60 | −23 | 59 | −30 |
| 85 | 62 | −26 | 62 | −23 | 61 | −31 |
| 90 | 63 | −31 | 63 | −23 | 63 | −25 |
| 95 | 63 | −25 | 63 | −22 | 63 | −31 |

Example C12

| | | | | | | |
|---|---|---|---|---|---|---|
| 65 | 0 | 0 | 0 | 0 | 0 | 0 |
| 70 | 1 | −1 | 1 | 0 | 1 | 0 |
| 75 | 3 | −1 | 3 | −1 | 3 | −1 |
| 80 | 10 | −2 | 11 | −2 | 10 | −2 |
| 85 | 23 | −5 | 24 | −6 | 24 | −5 |
| 90 | 32 | −9 | 34 | −10 | 33 | −9 |
| 95 | 37 | −11 | 39 | −11 | 39 | −11 |

Example C13

| | | | | | | |
|---|---|---|---|---|---|---|
| 65 | 0 | 0 | 0 | 0 | 0 | 0 |
| 70 | 2 | −1 | 2 | −1 | 2 | −1 |
| 75 | 10 | −2 | 11 | −2 | 10 | −2 |
| 80 | 25 | −5 | 25 | −5 | 23 | −5 |
| 85 | 37 | −10 | 38 | −11 | 36 | −10 |
| 90 | 43 | −12 | 44 | −12 | 42 | −12 |
| 95 | 49 | −13 | 50 | −13 | 47 | −13 |

The overall web roll width of Examples 11-21 and Comparative Examples C7-C13 were measured before and after stretching. Total neck-in % is the percentage of width reduction caused by stretching. As the amount of neck-in typically increases with increased stretching, a useful measure is the normalized neck-in which is the total neck-in divided by the draw ratio. Total Neck-in and normalized Neck-in are given in Table 14 except for Example 16 and Comparative Example C9.

TABLE 14
Neck-In for Examples 11-21 and Comparative Examples C7-C13

| | | Width before | Width after | | |
|---|---|---|---|---|---|
| | Draw | stretching | stretching | | Normalized |
| Example | ratio | (mm) | (mm) | Neck-in % | Neck-in |
| 11 | 5.0 | 25.0 | 22.0 | 12.0 | 2.4 |
| 12 | 5.0 | 25.0 | 20.5 | 18.0 | 3.6 |
| 13 | 5.0 | 25.0 | 20.5 | 18.0 | 3.6 |
| 14 | 5.0 | 25.0 | 20.3 | 19.0 | 3.8 |
| 15 | 5.0 | 24.8 | 21.0 | 15.2 | 3.0 |
| 16 | 5.0 | 25.0 | — | — | — |
| 17 | 5.0 | 24.8 | 21.5 | 13.1 | 2.6 |
| 18 | 4.0 | 24.8 | 21.5 | 13.1 | 3.3 |
| 19 | 3.5 | 24.8 | 18.5 | 25.3 | 7.2 |
| 20 | 4.0 | 24.8 | 18.8 | 24.2 | 6.0 |
| 21 | 5.0 | 25 | 19.5 | 22.0 | 4.4 |
| C7 | 4.3 | 25 | 15.0 | 40.0 | 9.2 |
| C8 | 3.2 | 24.8 | 19.0 | 23.2 | 7.2 |
| C9 | 5.0 | — | — | — | — |
| C10 | 4.0 | 25.0 | 18.3 | 27.0 | 6.8 |
| C11 | 3.0 | 25.0 | 18.3 | 27.0 | 8.9 |
| C12 | 4.9 | 25.0 | 18.0 | 28.0 | 5.7 |
| C13 | 4.9 | 25.0 | 18.8 | 25.0 | 5.1 |

Percent crystallinity was measured using DSC on samples after stretching. Results are given in Table 15. Samples with low post-stretching crystallinity tend to have higher TD growth as seen, for example in Comparative Examples C7, C10, and C11. For example, Comparative example C11 shows low stress-induced crystallinity (9.0%) because the films was stretched at a low draw ratio (3.0). Typically, the films should be stretched at a draw ratio sufficient to give greater than 15% crystallinity to maintain the TD growth at 0 to about 10%.

TABLE 15
DSC Crystallinity

| Example | Tg (2^{nd} Heat), ° C. | Crystallinity, % | Draw Ratio |
|---|---|---|---|
| 11 | 74 | 23.8 | 4.3 |
| 12 | 75 | 32.0 | 5.0 |
| 13 | 75 | 21.1 | 5.0 |
| 14 | 75 | 24.1 | 5.0 |
| 15 | 76 | 24.3 | 5.0 |
| 16 | 76 | 24.8 | 5.0 |
| 17 | 81 | 26.7 | 5.0 |
| 18 | 80 | 22.6 | 4.0 |
| 19 | 81 | 18.0 | 3.5 |
| 20 | — | — | 4.0 |
| 21 | 73 | 24.1 | 5.0 |
| C7 | 69 | 0 | 4.3 |
| C8 | 79 | 5.3 | 3.2 |
| C9 | — | — | 5.0 |
| C10 | 72 | 2.2 | 4.0 |
| C11 | 75 | 9.0 | 3.0 |
| C12 | 75 | 24.3 | 4.9 |
| C13 | 76 | 29.7 | 4.9 |

The shrink stress was measured for Examples 11-21 and Comparative Examples C7-C13 by a shrink force tester at 400° F. The shrink stress and gauge were measured at three locations on the web, operator side, center, and drive side, and the average was reported. Results are displayed in Table 16.

TABLE 16
Shrink Stress

| Example | Gauge (mil) | Shrink Stress (psi) | Shrink Stress (MPa) |
|---|---|---|---|
| 11 | 1.7 | 2674 | 18.44 |
| 12 | 2.0 | 2598 | 17.91 |
| 13 | 2.2 | 2201 | 15.18 |
| 14 | 2.1 | 2608 | 17.98 |
| 15 | 1.9 | 2614 | 18.02 |
| 16 | 1.9 | 2138 | 14.74 |
| 17 | 1.6 | 2735 | 18.86 |
| 18 | 2.2 | 1486 | 10.24 |
| 19 | 2.6 | 1040 | 7.17 |
| 20 | 2.8 | 1406 | 9.69 |
| 21 | 2.5 | 1631 | 11.25 |
| C7 | 3.0 | 1256 | 8.66 |
| C8 | 3.1 | 936 | 6.46 |
| C9 | 2.3 | 1659 | 11.44 |
| C10 | 3.2 | 1047 | 7.22 |
| C11 | 3.4 | 816 | 5.63 |
| C12 | 2.4 | 1621 | 11.17 |
| C13 | 2.2 | 1784 | 12.30 |

Examples 11-13 had the same polyester blend composition, as shown in Table 11 and show the impact of line speed on shrink film properties. The MD shrinkage properties were consistent across the web each of Examples 11-13. Significant position dependence was not observed for MD shrinkage. Furthermore, TD shrinkage or growth did not exceed 6%, and was less variable across the web than for Comparative Examples C1-C4.

Example 14 and Comparative Examples C12 and C13 had similar compositions, as shown in Table 11, and show the impact of annealing on shrink film properties. For Example 14, the annealing and cooling rolls A7-A13 were set at 168° C., 140° C., 122° C., 104° C., 104° C., 104° C., and 86° C., respectively. For Example C12 the annealing and cooling rolls A7-A13 were set at 180° C., 180° C., 180° C., 180° C., 180° C., 104° C., and 86° C., respectively. For Example C13 the annealing and cooling rolls A7-A13 were set at 180° C., 180° C., 122° C., 104° C., 104° C., 104° C., and 86° C., respectively. Annealing did reduce the MD shrinkage, Tables 12 and 13, and the shrink stress, Table 16. Annealing also increased TD growth because of the extra neck-in at the annealing zone. In order to maintain the TD growth of the finished film at 0 to about 10 percent, therefore, annealing should be performed under low tension to minimize the amount of additional total neck-in to 0.5% or less.

Examples 15 and 16 had similar compositions, as shown in Table 11, and show the impact of relaxation of shrink film properties. For Example 15, annealing and cooling rolls A8-A11 had friction ratios of 0.96, 0.96, 0.96, and 0.99, respectively. The relaxation did not have a significant effect on shrinkage properties as seen in Tables 12 and 13. The relaxation did reduce the shrink stress of Example 16 compared to Example 15 as shown in Table 16. In Example 17, wrinkles developed in the relaxed film.

Example 22 and Comparative Example C14—Example 22 was prepared from a reactor grade polyester having 100 mole percent terepthalic acid, 12.2 mole percent 1,4-CHDM, 1.4 mole percent diethylene glycol, and 86.4 mole percent ethylene glycol. Comparative Example C14 had the same composition as polyester (B). The films were stretch in the MD at the stretch ratios indicated in Table 17. All shrink curves were measured in water for 10 seconds at 65° C. to 95° C. at 5° C. increments for three positions across the web. Shrinkage data is shown in Table 17. Table 18 shows the crystallinity of the samples after stretching.

TABLE 17
10 Second Shrinkage Data for Reactor Grade Polyesters

| | Operator Side | | Center | | Drive Side | |
|---|---|---|---|---|---|---|
| Temperature, | Shrinkage, % | | Shrinkage, % | | Shrinkage, % | |
| ° C. | MD | TD | MD | TD | MD | TD |

Comparative Example C14 (5X Stretch)

| | | | | | | |
|---|---|---|---|---|---|---|
| 65 | 7 | −4 | 8 | −4 | 8 | −5 |
| 70 | 38 | −25 | 40 | −25 | 37 | −24 |
| 75 | 61 | −55 | 62 | −52 | 62 | −55 |
| 80 | 73 | −75 | 73 | −64 | 62 | −75 |
| 85 | 75 | −80 | 75 | −66 | 76 | −80 |
| 90 | 76 | −81 | 76 | −65 | 76 | −84 |
| 95 | 76 | −81 | 76 | −62 | 76 | −86 |

Example 22 (5X Stretch)

| | | | | | | |
|---|---|---|---|---|---|---|
| 65 | 2 | 1 | 1 | 1 | 1 | 1 |
| 70 | 2 | 1 | 2 | 1 | 2 | 1 |
| 75 | 3 | 2 | 3 | 3 | 2 | 2 |
| 80 | 6 | 5 | 8 | 5 | 6 | 5 |
| 85 | 15 | 6 | 15 | 6 | 13 | 6 |
| 90 | 21 | 5 | 21 | 5 | 19 | 5 |
| 95 | 26 | 4 | 27 | 5 | 25 | 5 |

Example 22 (4X Stretch)

| | | | | | | |
|---|---|---|---|---|---|---|
| 65 | 0 | 0 | 0 | 0 | 0 | 0 |
| 70 | 1 | 1 | 2 | 1 | 1 | 1 |
| 75 | 4 | 4 | 5 | 5 | 5 | 4 |
| 80 | 15 | 5 | 18 | 8 | 17 | 5 |
| 85 | 32 | 1 | 34 | 3 | 32 | 1 |
| 90 | 40 | 2 | 42 | 0 | 41 | −1 |
| 95 | 46 | −5 | 46 | 0 | 46 | −2 |

Example 22 (3.5X Stretch)

| | | | | | | |
|---|---|---|---|---|---|---|
| 65 | 0 | 0 | 0 | 0 | 0 | 0 |
| 70 | 2 | 0 | 2 | 0 | 2 | 0 |
| 75 | 5 | 2 | 7 | 2 | 6 | 1 |
| 80 | 26 | 1 | 26 | 1 | 27 | −1 |
| 85 | 42 | −7 | 45 | −6 | 44 | −7 |
| 90 | 49 | −10 | 50 | −7 | 48 | −8 |
| 95 | 52 | −10 | 53 | −5 | 52 | −9 |

TABLE 18
Crystallinity of Films Samples After Stretching

| Example | Crystallinity, % | Draw Ratio, X |
|---|---|---|
| C14 | 0 | 4.33 |
| 22 (5X) | 26.7 | 5.02 |
| 22 (4X) | 22.6 | 4.03 |
| 22 (3.5X) | 18.0 | 3.50 |

We claim:

1. A polyester blend comprising:
A. a first polyester comprising:
i. diacid residues comprising about 90 to 100 mole percent, based on the total first polyester diacid residues, of the residues of terephthalic acid; and
ii. diol residues comprising about 90 to 100 mole percent, based on the total first polyester diol residues, of the residues of ethylene glycol;
and
B. a second polyester comprising:
i. diacid residues comprising about 90 to 100 mole percent, based on the total second polyester diacid residues, of the residues of terephthalic acid; and
ii. diol residues comprising about 5 to about 89 mole percent, based on the total second polyester diol residues, of the residues of ethylene glycol, about 10 to about 70 mole percent of the residues of 1,4-cyclohexanedimethanol residues, and about 1 to about 25 mole percent of the residues of diethylene glycol;
wherein said polyester blend comprises about 8 to about 15 mole percent, based on the total diol residues in said polyester blend, of the residues of 1,4-cyclohexanedimethanol.

2. The polyester blend according to claim 1, wherein said first polyester (A) comprises about 95 to 100 mole percent of the residues of terephthalic acid.

3. The polyester blend according to claim 2, wherein said first polyester (A) comprises about 2 to about 5 mole percent of the residues of 1,4-cyclohexanedimethanol, and about 2 to about 5 mole percent of the residues of diethylene glycol.

4. The polyester blend according to claim 1, wherein said first polyester (A) comprises from about 10 to about 100 weight percent recycled polyester, based on the total weight of said first polyester.

5. The polyester blend according to claim 1, wherein said second polyester (B) comprises about 95 to 100 mole percent terephthalic acid residues, about 35 to about 89 mole percent ethylene glycol residues, and about 10 to about 40 mole percent 1,4-cyclohexanedimethanol residues.

6. The polyester blend according to claim 5, wherein said second polyester (B) comprises about 50 to about 77 mole percent ethylene glycol residues, about 15 to about 35 mole percent 1,4-cyclohexanedimethanol residues, and about 8 to about 15 mole percent diethylene glycol residues.

7. The polyester blend according to claim 6, which comprises about 40 to about 60 weight percent of said first polyester (A) and about 60 to about 40 weight percent of said second polyester (B).

8. The polyester blend accord to claim 7, which comprises about 50 weight percent of said first polyester (A) and about 50 weight percent of said second polyester (B).

9. A heat shrinkable, polyester film comprising a polyester blend, said polyester blend comprising:
A. a first polyester comprising
i. diacid residues comprising about 90 to 100 mole percent, based on the total first polyester diacid residues, of the residues of terephthalic acid; and
ii. diol residues comprising about 90 to 100 mole percent, based on the total first polyester diol residues, of the residues of ethylene glycol;
and
B. a second polyester comprising
i. diacid residues comprising about 90 to 100 mole percent, based on the total second polyester diacid residues, of the residues of terephthalic acid; and
ii. diol residues comprising about 5 to about 89 mole percent, based on the total second polyester diol residues, of the residues of ethylene glycol, about 10 to about 70 mole percent of the residues of 1,4-cyclohexanedimethanol residues, and about 1 to about 25 mole percent of the residues of diethylene glycol;
wherein said polyester blend comprises about 8 to about 15 mole percent, based on the total diol residues in said polyester blend, of the residues of 1,4-cyclohexanedimethanol, and said film has about 25 to about 85 percent machine direction shrinkage and about 0 to about 10 percent transverse direction shrinkage or growth when immersed in water at 95° C. for 10 seconds.

10. The heat-shrinkable film according to claim 9, wherein said first polyester (A) comprises about 95 to 100 mole percent of the residues of terephthalic acid, about 2 to about 5 mole percent of the residues of 1,4-cyclohexanedimethanol, and about 2 to about 5 mole percent of the residues of diethylene glycol.

11. The heat-shrinkable film according to claim 9, wherein said second polyester (B) comprises about 95 to 100 mole percent terephthalic acid residues, about 35 to about 89 mole percent ethylene glycol residues, and about 10 to about 40 mole percent 1,4-cyclohexanedimethanol residues.

12. The heat-shrinkable film according to claim 11, wherein said second polyester (B) comprises about 50 to about 77 mole percent ethylene glycol residues, about 15 to about 35 mole percent 1,4-cyclohexanedimethanol residues, and about 8 to about 15 mole percent diethylene glycol residues.

13. The heat-shrinkable film according to claim 12, which comprises about 40 to about 60 weight percent of said first polyester (A) and about 60 to about 40 weight percent of said second polyester (B).

14. The heat-shrinkable film according to claim 13, which comprises about 50 weight percent of said first polyester (A) and about 50 weight percent of said second polyester (B).

15. The heat-shrinkable film according to claim 9, which is stretched at a draw ratio of about 2 to about 6 in the machine direction and at a draw ratio of 0 to about 2 in the transverse direction.

16. The heat-shrinkable film according to claim 9, which has about 35 to about 60 percent machine direction shrinkage and 0 to about 7 percent transverse direction shrinkage or growth.

17. The heat-shrinkable film according to claim 9, wherein said first polyester (A) comprises from about 10 to about 100 weight percent recycled polyester.

18. The heat-shrinkable film of claim 9 which is produced by extrusion, calendering, casting, drafting, tentering, or blowing.

19. A sleeve or roll-fed label comprising said heat-shrinkable film of claim 18.

20. The sleeve or label of claim 19, which is seamed by solvent bonding, hot-melt glue, UV-curable adhesive, radio frequency sealing, heat sealing, or ultrasonic bonding.

21. A void-containing, heat shrinkable, polyester film, comprising:
I. a polyester blend comprising
A. a first polyester comprising
i. diacid residues comprising about 90 to 100 mole percent, based on the total first polyester diacid residues, of the residues of terephthalic acid; and
ii. diol residues comprising about 90 to 100 mole percent, based on the total first polyester diol residues, of the residues of ethylene glycol;
and
B. a second polyester comprising
i. diacid residues comprising about 90 to 100 mole percent, based on the total second polyester diacid residues, of the residues of terephthalic acid; and
ii. diol residues comprising about 5 to about 89 mole percent, based on the total second polyester diol residues, of the residues of ethylene glycol, about 10 to about 70 mole percent of the residues of 1,4-cyclohexanedimethanol residues, and about 1 to about 25 mole percent of the residues of diethylene glycol;
wherein said polyester blend comprises about 8 to about 15 mole percent, based on the total diol residues in said polyester blend, of the residues of 1,4-cyclohexanedimethanol;
and
II. a voiding agent, comprising at least one polymer incompatible with said polyester blend and dispersed therein;
wherein said film has about 25 to about 85 percent machine direction shrinkage and about 0 to about 10 percent transverse direction shrinkage or growth when immersed in water at 95° C. for 10 seconds.

22. The void-containing film according to claim 21 wherein said voiding agent comprises at least one polymer chosen from cellulosic polymers, starch, esterified starch, polyketones, polyesters, polyamides, polysulfones, polyimides, polycarbonates, olefinic polymers, and copolymers thereof.

23. The void-containing film of claim 22 wherein said voiding agent comprises a first polymer comprising cellulose acetate, cellulose triacetate, cellulose acetate proprionate, cellulose acetate butyrate, hydroxypropyl cellulose, methyl ethyl cellulose, carboxymethyl cellulose, or mixtures thereof; and a second polymer comprising polyethylene, polystyrene, polypropylene, ethylene vinyl acetate, ethylene vinyl alcohol copolymer, ethylene methyl acrylate copolymer, ethylene butyl acrylate copolymer, ethylene acrylic acid copolymer, ionomer, or mixtures thereof.

24. The void-containing film of claim 23 wherein said first polymer comprises cellulose acetate, cellulose acetate propionate, or a mixture thereof; and said second polymer comprises polystyrene, polypropylene, ethylene methyl methacrylate copolymer, or a mixture thereof.

25. A sleeve or roll-fed label comprising said shrink film of claim 21.

26. A process for the preparation of a heat shrinkable, polyester film comprising:
I. melt blending
A. a first polyester comprising:
i. diacid residues comprising about 90 to 100 mole percent, based on the total first polyester diacid residues, of the residues of terephthalic acid; and
ii. diol residues comprising about 90 to 100 mole percent, based on the total first polyester diol residues, of the residues of ethylene glycol; and
B. a second polyester comprising:
i. diacid residues comprising about 90 to 100 mole percent, based on the total second polyester diacid residues, of the residues of terephthalic acid; and
ii. diol residues comprising about 5 to about 89 mole percent, based on the total second polyester diol residues, of the residues of ethylene glycol, about 10 to about 70 mole percent of the residues of 1,4-cyclohexanedimethanol residues, and about 1 to about 25 mole percent of the residues of diethylene glycol;
to form a miscible, polyester blend comprising about 8 to about 15 mole percent, based on the total diol residues in said polyester blend, of the residues of 1,4-cyclohexanedimethanol;
II. forming said polyester blend into a film; and
III. stretching said film of step (II) in the machine direction,
wherein the film has about 25 to about 85 percent machine direction shrinkage and about 0 to about 10 percent transverse direction shrinkage or growth when immersed in water at 95° C. for 10 seconds.

27. A heat shrinkable, roll-fed label, comprising about 60 to about 100 weight percent, based on the total weight of said label, of a reaction-grade polyester, said reaction-grade polyester comprising:
i. diacid residues comprising about 90 to 100 mole percent, based on the total diacid residues, of the residues of terephthalic acid; and
ii. diol residues comprising about 75 to about 87 mole percent ethylene glycol residues, about 8 to about 15 mole percent 1,4-cyclohexanedimethanol residues, and about 5 to about 10 mole percent diethylene glycol residues;
wherein said roll-on label is stretched in the machine direction at a draw ratio from about 2 to about 6 and has about 25 to about 85 percent machine direction shrinkage and 0 to about 10 percent transverse direction shrinkage or growth when immersed in water at 95° C. for 10 seconds.

28. The roll-on label according to claim 27 which further comprises a voiding agent a comprising at least one polymer incompatible with said reaction-grade polyester and dispersed therein.

29. The roll-on label according to claim 28 wherein said voiding agent comprises a first polymer comprising cellulose acetate, cellulose acetate propionate, or a mixture thereof; and a second polymer comprising polystyrene, polypropylene, ethylene methyl methacrylate copolymer, or a mixture thereof.
